(19) United States
(12) Patent Application Publication
(10) Pub. No.: US 2019/0116094 A1
(43) Pub. Date: Apr. 18, 2019

(54) METHOD AND SYSTEM FOR TRANSFERABLE CUSTOMIZED CONTEXTUAL USER INTERFACES

(71) Applicant: Synacor, Inc., Buffalo, NY (US)

(72) Inventors: Gabor Vida, Ottawa (CA); Stephen MacKenzie, Ottawa (CA); Anthony David MacDonnell, Ottawa (CA)

(21) Appl. No.: 16/207,173

(22) Filed: Dec. 2, 2018

Related U.S. Application Data
(63) Continuation of application No. 14/427,158, filed on Mar. 10, 2015.
(60) Provisional application No. 61/698,757, filed on Sep. 10, 2012.

(51) Int. Cl. H04L 12/24; H04L 29/06; H04L 29/08; G06F 9/445; G06F 9/451

(52) U.S. Cl. CPC H04L 41/22; H04L 67/38; G06F 9/451; G06F 9/4451; H04L 67/306

(57) ABSTRACT

Electronic devices have become ubiquitous providing users with dynamically adaptive applications and user interfaces. An electronic device may have multiple user customized interfaces which is further amplified by multiple users for the same electronic device, each having multiple user customized UI dashboard configurations. Accordingly, replacement of the electronic device or addition of another electronic device requires that the users expend significant effort generating these user customized UI dashboard configurations again. It would therefore be beneficial for such user customized UI dashboard configurations to be archived and accessible to a user upon such events as replacement or acquisition. It would also be beneficial for enterprises to be able to provide a user with context sensitive dashboards as part of their customer engagement. Additionally, it would be beneficial for a user to be able to access their user customized UI dashboard from another electronic device other than their personal electronic device.

### CROSS-REFERENCE TO RELATED APPLICATIONS

This patent application is a Continuation Application of U.S. patent application Ser. No. 14/427,158, which application claims the benefit of U.S. Provisional Patent Application 61/698,757 filed on Sep. 10, 2012 entitled “Method and System for Transferable Customized Contextual User Interfaces,” which applications are incorporated herein in their entireties.

### FIELD OF THE INVENTION

The present invention relates to the user interfaces and in particular to methods and systems for transferring customized contextual user interfaces.

### BACKGROUND OF THE INVENTION

A user interface, in the industrial design field of human—machine interaction, is the “space” where interaction between humans and machines occurs. The goal of interaction between a human and a machine at the user interface is effective operation and control of the machine, and feedback from the machine to the user which aids the user in making operational decisions. Examples of this broad concept of user interfaces include the interactive aspects of computer operating systems, hand tools, heavy machinery operator controls, and process controls. The design considerations applicable when creating user interfaces are related to or involve such disciplines as ergonomics and psychology.

Accordingly, a user interface is the system by which people (users) interact with a machine (device) and includes hardware (physical) and software (logical) components. User interfaces exist for a wide variety of systems, and provide a means of:
Input—allowing the users to manipulate a system; and
Output—allowing the system to indicate the effects of the users' manipulation.

Generally, the goal of human-machine interaction engineering is to produce a user interface which makes it easy, efficient, and enjoyable to operate a machine in the way which produces the desired result. This generally means that the operator needs to provide minimal input to achieve the desired output, that the machine minimizes undesired outputs to the human, and that the inputs provided by the operator are intuitive and logical. With the increased use of microprocessor based systems and the relative decline in societal awareness of heavy machinery, the term user interface has taken on overtones of the graphical user interface for electronic devices and systems, whilst industrial control panels and machinery control design discussions more commonly refer to human-machine interfaces. Other common terms for user interface include human-computer interface (HCI) and man-machine interface (MMI).

User interfaces are considered by some authors to be a prime ingredient of Computer user satisfaction. This arises as the design of a user interface affects the amount of effort the user must expend to provide input for the system and to interpret the output of the system, and how much effort it takes to learn how to do this. Usability is the degree to which the design of a particular user interface takes into account the human psychology and physiology of the users, and makes the process of using the system effective, efficient and satisfying.

Usability is mainly a characteristic of the user interface, but is also associated with the functionalities of the product and the process to design it. It describes how well a product can be used for its intended purpose by its target users with efficiency, effectiveness, and satisfaction, also taking into account the requirements from its context of use. In computer science and human-computer interaction, the user interface (of a computer program and/or electronic device) refers to the graphical, textual and auditory information presented to the user, and the control sequences (such as keystrokes with a computer keyboard or touchpad, movements of a computer mouse or finger on a touchpad, and other selections with one or more interfaces to the computer program and/or electronic device that the user employs to control the program

Direct manipulation interfaces refer to a general class of user interfaces that allows users to manipulate objects presented to them, using actions that correspond at least loosely to the physical world. However, to date the prior art solutions are confusingly referred to as direct machine interfaces as the user directly selects a feature or an item through an action with a keyboard, touchpad or other input device. However, a point-and-click or touch operation by a user to select an item for movement does not correspond to the physical world where the user would normally pick the item through a pinching or gripping motion with their hand.

Currently, the following types of user interface are the most common, graphical user interfaces (GUI) and web-based user interfaces (WUI, also known as web user interfaces).

A GUI accepts user input via devices such as keyboard, mouse, and touchpad and provide articulated graphical input/output on the device's display. There are at least two different principles widely used in GUI design, object-oriented user interfaces (OOUIs) and application oriented interfaces (AOIs). Implementations may utilize one or more languages including, but not limited to, and be designed to operate with one or more operating systems, including but not limited to, Symbian, OpenIndiana, Haiku, Android, Windows, Mac OS, iOS, RISC OS, GNU/Linux, Tablet OS, and Blackberry OS as appropriate for portable electronic devices (PEDs) and for fixed electronic devices (FEDs).

A WUI accepts input and provide output by generating web pages which are transmitted via the Internet and viewed by the user using a web browser program. Implementations may utilize Java, AJAX, Adobe Flex, Microsoft .NET, or similar technologies to provide real-time control in a separate program, eliminating the need to refresh a traditional HTML based web browser. Administrative web interfaces for web-servers, servers and networked computers are often called control panels.

Originally user interfaces employed command line interfaces, where the user provided the input by typing a command string with the computer keyboard and the system provided output by printing text on the computer monitor. In many instances, such interfaces are still used by programmers and system administrators, in engineering and scientific environments, and by technically advanced personal computer users. These were then augmented in the past with the introduction of controls (also known as widgets) including but not limited to windows, text boxes, buttons, hyperlinks, drop-down lists, tabs, and pop-up menu which may be augmented by Interaction elements are interface objects that represent the state of an ongoing operation or transformation, either as visual remainders of the user intent (such as the pointer), or as affordances showing places where the user may interact including, but not limited to, cursors, pointers and adjustment handles.

Today user interfaces have evolved to include:

Attentive user interfaces manage the user attention deciding when to interrupt the user, the kind of warnings, and the level of detail of the messages presented to the user.

Batch interfaces are non-interactive user interfaces, where the user specifies all the details of the batch job in advance to batch processing, and receives the output when all the processing is done.

Conversational Interface Agents attempt to personify the computer interface in the form of an animated person, robot, or other character and present interactions in a conversational form.

Crossing-based interfaces are graphical user interfaces in which the primary task consists in crossing boundaries instead of pointing.

Gesture interfaces are graphical user interfaces which accept input in a form of hand gestures, or mouse gestures sketched with a computer mouse or a stylus.

Intelligent user interfaces are human-machine interfaces that aim to improve the efficiency, effectiveness, and naturalness of human-machine interaction by representing, reasoning, and acting on models of the user, domain, task, discourse, and media (e.g., graphics, natural language, gesture).

Motion tracking interfaces monitor the user's body motions and translate them into commands.

Multi-screen interfaces, which employ multiple displays to provide a more flexible interaction and are often employed in computer game interactions.

Non-command user interfaces, which observe the user to infer his/her needs and intentions, without requiring that he/she formulate explicit commands.

Object-oriented user interfaces (OOUI) are based on object-oriented programming metaphors, allowing users to manipulate simulated objects and their properties.

Reflexive user interfaces where the users control and redefine the entire system via the user interface alone, for instance to change its command verbs.

Tangible user interfaces, which place a greater emphasis on touch and physical environment or its element.

Task-Focused Interfaces are user interfaces which address the information overload problem of the desktop metaphor by making tasks, not files, the primary unit of interaction

Text user interfaces are user interfaces which output text, but accept other forms of input in addition to or in place of typed command strings.

Voice user interfaces, which accept input and provide output by generating voice prompts. The user input is made by pressing keys or buttons, or responding verbally to the interface.

Natural-Language interfaces—Used for search engines and on webpages. User types in a question and waits for a response.

Zero-Input interfaces get inputs from a set of sensors instead of querying the user with input dialogs.

Zooming user interfaces are graphical user interfaces in which information objects are represented at different levels of scale and detail, and where the user can change the scale of the viewed area in order to show more detail.

However, despite the evolution of these multiple types of user interface these all treat the environment of the user upon the portable or fixed electronic device as a stable environment and do not fundamentally adjust the user interface or other aspects of the environment including the features and applications available based upon the user as an individual but rather assume all users engage an application in the same manner.

A property of a good user interface is consistency and providing the user with a consistent set of expectations, and then meeting those expectations. Like any other principle, consistency has its limits and can be bad when it fails to have a purpose or serve any benefit to the end user. Consistency is one quality traded off in user interface design as described by the cognitive dimensions framework. In some cases, a violation of consistency principles can provide sufficiently clear advantages that a wise and careful user interface designer may choose to violate consistency to achieve some other important goal.

There are generally three aspects identified as relevant to consistency. First, the controls for different features should be presented in a consistent manner so that users can find the controls easily. For example, users find it difficult to use software when some commands are available through menus, some through icons, some through right-clicks, some under a separate button at one corner of a screen, some grouped by function, some grouped by “common,” some grouped by “advanced.” A user looking for a command should have a consistent search strategy for finding it. The more search strategies a user has to use, the more frustrating the search will be. The more consistent the grouping, the easier the search. The principle of monotony of design in user interfaces states that ideally there should be only way to achieve a simple operation, to facilitate habituation to the interface.

Second, there is the principle of astonishment in that various features should work in similar ways and hence an interface should not in one embodiment or situation require the user to “select feature, then select function to apply” and then in other situations “select function, and then select feature to apply. Commands should work the same way in all contexts. Third, consistency counsels against user interface changes version-to-version. Change should be minimized, and forward-compatibility should be maintained which adjusts as devices and interfaces mature. Traditionally, less mature applications and hardware had fewer users who were entrenched in any status quo and older, more broadly used applications and hardware had to carefully hew to the status quo to avoid disruptive costs and user backlash. However, today a new application and/or hardware element which is successful within the consumer field will evolve from nothing to millions of users within a very short period of time. For example, the Apple iPad™ was released April 2010 and sold 3 million units within the first 80 days. In the eight months of 2010 these sales totaled 14.8 million and in late 2011 Apple was widely believed to be on track to sell 40 million devices that year.

The design of user interfaces widely exploit mental models, which are generally founded on difficult to quantify, obscure, or incomplete facts, flexible which is considerably variable in positive as well as in negative sense, act as an information filter which cause selective perception (i.e. perception of only selected parts of information) and in many instances are limited when compared with the complexities surrounding the world. For example, the recently released Samsung Galaxy™ smartphone uses facial recognition to unlock the smartphone for a single user but does not perform any additional functionality as all protection is lost by simply giving the unlocked smartphone to another user.

Mental models are a fundamental way to understand organizational learning and in many instances are based upon deeply held images of thinking and acting. Mental models are so basic to understanding of the world that people are hardly conscious of them and are generally expressed in a couple of basic forms including:
Polygons—where vertices sharing an edge represent related items;
Causal-loop diagrams—which display tendency and a direction of information connections and the resulting causality; and
Flow diagrams—which are used to express a dynamic system.

Accordingly, users whilst unaware of the mental models employed anticipate users interfaces, software, and hardware to behave in particular ways, and going against entrenched mental models will result in users feeling one or more of confused, ignored, and dissatisfied. Today, social media means that these users can rapidly express their opinions to a wide audience and negatively impact the commercial success of the software and/or hardware.

With the widespread penetration of portable electronic devices to consumers today a smartphone must support intuitive interfaces, provide rapid switching between applications allowing a user to browse, text, view, play, comment, etc through direct email, web based email, simple message service (SMS), telephony, multimedia applications, downloaded and online gaming, social media services, streamed multimedia content, etc. At the same time these portable electronic devices include multiple wireless interfaces, including but not limited to IEEE 802.11, IEEE 802.15, IEEE 802.16, IEEE 802.20, UMTS, GSM 850, GSM 900, GSM 1800, GSM 1900, and GPRS as well as one or more of Near Field Communication (NFC) interfaces, accelerometers, global positioning systems (GPS), and compass so that the devices are location aware and third party applications utilizing this information are increasing such as Google's Latitude, Apple's Find My Friends, and Singles Around Me.

With their ubiquitous nature and perceived personalized character smartphones are increasingly being targeted for other aspects of an individual's life such as purchasing with MasterCard's PayPass program or Visa's payWave, banking with applications from institutions such as Bank of America, Chase, PayPal, Wells Fargo, Capital One, American Express, and insurance with applications from State Farm etc as well as medical, news, lifestyle, health and fitness, and education. Accordingly, portable electronic devices such as a cellular telephone, smartphone, personal digital assistant (PDA), portable computer, pager, portable multimedia player, portable gaming console, laptop computer, tablet computer, and an electronic reader contain confidential and sensitive information relating to the user.

It is therefore increasingly beneficial for these electronic devices to adapt the applications, information, user interface etc. presented to a user based upon the identity of the user. But additionally, it would be beneficial for these aspects to be adjusted based upon the context of the user's use of the electronic device. Such principles, however, also apply to non-portable electronic devices such as Internet enable televisions, gaming systems, and desktop computers.

Accordingly, user interfaces and electronic devices may be established on electronic devices based upon biometric recognition, environmental context, and dynamic reconfiguration with changing context, intuitive interfaces, and micro-contexts. As such an electronic device for a user may now have two, three, or more user customized user interface (UI) configurations. This may be further amplified by multiple users for the same electronic device, each having multiple user customized UI dashboard configurations. Accordingly, replacement of the electronic device or addition of another electronic device requires that the users expend significant effort generating these user customized UI dashboard configurations again.

It would therefore be beneficial for such user customized UI dashboard configurations to be archived and accessible to a user upon such events as replacement or acquisition. It would also be beneficial for enterprises to be able to provide a user with context sensitive dashboards as part of their customer engagement. Additionally, it would be beneficial for a user to be able to access their user customized UI dashboard from another electronic device other than their personal electronic device.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations in the prior art relating to user interfaces and in particular to methods and systems for establishing dynamically assignable user interfaces.

In accordance with an embodiment of the invention there is provided a method comprising:
providing a microprocessor forming part of an electronic device executing a user interface application relating to a user interface for the electronic device;
providing a memory forming part of the electronic device for storing: the user interface application,
at least one contextual dashboard of a plurality of contextual dashboards; and
providing at least one communications interface coupled to a communications network;
determining whether a user of the electronic device has modified the at least one contextual dashboard of the plurality of contextual dashboards; and
transmitting when the determination is positive data to a remote server connected to the communications detector, the data relating to the modified contextual dashboard of the plurality of contextual dashboards.

In accordance with an embodiment of the invention there is provided a method comprising:
receiving at a server first data relating to an electronic device and an identity of a user associated with the electronic device;
receiving at the server second data relating to at least one contextual dashboard of a plurality of contextual dashboards associated with a user interface application for the electronic device;
receiving at the server third data relating to the user;
transferring to the electronic device fourth data relating to the at least one contextual dashboard of a plurality of contextual dashboards.

In accordance with an embodiment of the invention there is provided a method comprising:
providing a memory forming part of a server coupled to a communications network, the memory storing a plurality of contextual dashboards;
receiving from an electronic device coupled to the communications network data relating to a context of the electronic device;
determining a contextual dashboard of the plurality of contextual dashboards, the determination made in dependence of at least the data relating to the context of the electronic device;
transferring to the electronic device via the communications network the determined contextual dashboard of the plurality of contextual dashboards.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a contextual UI mental model according to an embodiment of the invention;

FIG. 2 depicts a contextual UI mental model according to an embodiment of the invention;

FIG. 3 depicts an exemplary profile layer flow according to an embodiment of the invention;

FIG. 4 depicts an exemplary migration of contextual dashboard layers for a user according to an embodiment of the invention;

FIG. 5 depicts an exemplary contextual dashboard in travel mode presented to a user according to an embodiment of the invention;

FIG. 6 depicts an exemplary contextual dashboard in travel (vacation) mode presented to a user with application options according to an embodiment of the invention;

FIG. 7 depicts an exemplary contextual dashboard in work mode presented to a user according to an embodiment of the invention;

FIG. 8 depicts an exemplary work screen in work mode with application tasks presented to a user according to an embodiment of the invention;

FIG. 9 depicts user dashboard customization and extended dashboard configuration and dynamic mapping to electronic device according to embodiments of the invention;

FIG. 10 depicts residential and office environments and elements within that provide micro-contexts for UIs according to an embodiment of the invention;

FIG. 11 depicts an exemplary process flow for user and context determination of macro- and micro-context factors according to an embodiment of the invention;

FIG. 12 depicts a network supporting communications to and from electronic devices implementing contextual based UIs according to embodiments of the invention;

FIG. 13 depicts an electronic device and network access point supporting contextual based UIs according to embodiments of the invention;

FIG. 14 depicts a portable electronic device having multiple associated users each with user customized contextual based UI dashboards according to an embodiment of the invention;

FIG. 15 depicts user and sales agent based initialization of a user customized contextual based UI dashboard and subsequent transfer to the user's purchased portable electronic device according to an embodiment of the invention;

FIG. 16 depicts a web based server hosting system according to an embodiment of the invention providing recovery and new installation services relating to user customized contextual based UI dashboards according to an embodiment of the invention;

FIG. 17 depicts web and enterprise based provisioning of non-user defined contextual based UI dashboards according to an embodiment of the invention;

FIG. 18 depicts customized UI dashboard generation to users by an enterprise in dependence upon templates transferred from their portable electronic devices according to an embodiment of the invention; and

FIG. 19 depicts customized contextual UI dashboard provisioning to a user upon different devices accessed in different locations according to an embodiment of the invention.

### DETAILED DESCRIPTION

The present invention is directed to user interfaces and in particular to methods and systems for establishing dynamically assignable user interfaces.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “mobile electronic device” as used herein and throughout this disclosure, refers to a wireless device used for communication that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader. A “fixed electronic device” (FED) as used herein and throughout this disclosure, refers to a wireless device or wired device used for communication that does not require a battery or other independent form of energy for power. This includes devices, but is not limited to, Internet enable televisions, gaming systems, desktop computers, kiosks, and Internet enabled communications terminals.

A “network operator” or “network service provider” as used herein may refer to, but is not limited to, a telephone or other company that provides services for mobile phone subscribers including voice, text, and Internet; telephone or other company that provides services for subscribers including but not limited to voice, text, Voice-over-IP, and Internet; a telephone, cable or other company that provides wireless access to local area, metropolitan area, and long-haul networks for data, text, Internet, and other traffic or communication sessions; etc.

A “software system” as used as used herein may refer to, but is not limited to, a server based computer system executing a software application or software suite of applications to provide one or more features relating to the licensing, annotating, publishing, generating, rendering, encrypting, social community engagement, storing, merging, and rendering electronic content and tracking of user and social community activities of electronic content. The software system being accessed through communications from a “software application” or “software applications” and providing data including, but not limited to, electronic content to the software application. A “software application” as used as used herein may refer to, but is not limited to, an application, combination of applications, or application suite in execution upon a portable electronic device or fixed electronic device to provide one or more features relating to one or more features relating to generating, rendering, managing and controlling a user interface. The software application in its various forms may form part of the operating system, be part of an application layer, or be an additional layer between the operating system and application layer.

A “user” as used herein and through this disclosure refers to, but is not limited to, a person or device that utilizes the software system and/or software application and as used herein may refer to a person, group, or organization that has registered with the software system and/or software application to acquire primary content and generates secondary content in association with the primary content. A “user interface” as used herein and through this disclosure refers to, but is not limited to a graphical user interface (GUI) and/or web-based user interface (WUI) which accepts user input from one or more user input devices and provides output to the user. Typically, the user interface will provide articulated graphical input/output on a display and/or screen of an electronic device but may also provide articulated graphical output in conjunction with audio and/or tactile output as well as accepting input through audio, visual, and haptic interfaces.

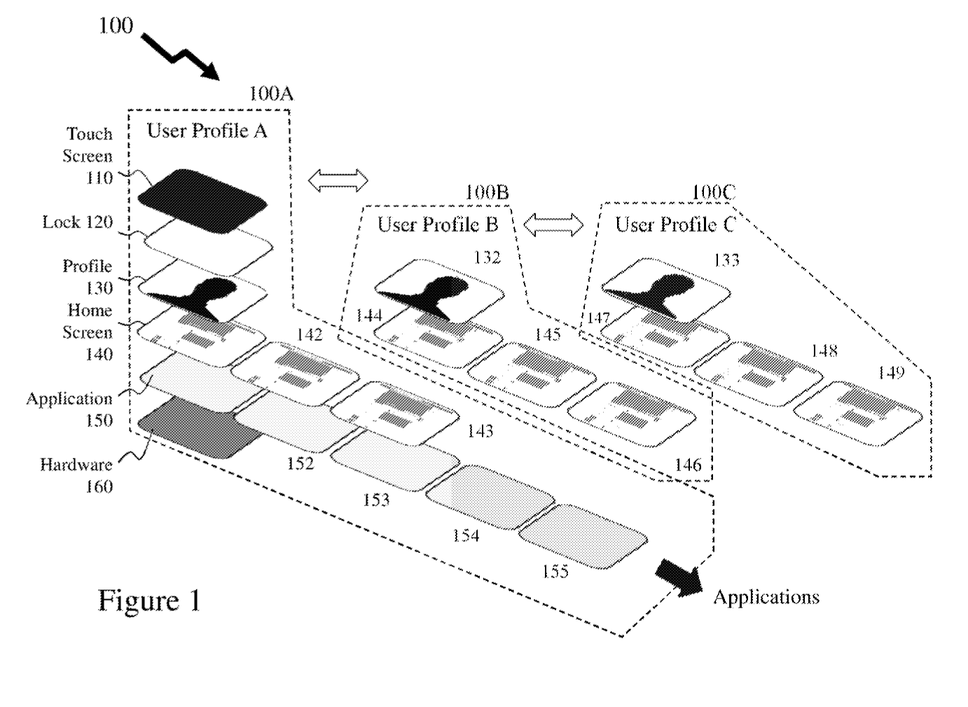

Referring to FIG. 1 there is depicted a contextual UI mental model 100 according to an embodiment of the invention. Within the contextual UI mental model 100 first to third user profiles 100A through 100C are depicted for Users A, B, and C respectively. Considering first user profile 100A then this comprises a plurality of layers denoted as Touch Screen 110, Lock 120, Profile 130, Contextual dashboard 140, Application 150 and Hardware 160 wherein the contextual UI mental model 100 is implemented upon a portable electronic device such as a smartphone, tablet PC, and PDA wherein Touch Screen 110 provides the primary user input through the touch sensitive surface and the primary user output through the LCD/LED display. Accordingly, a user accessing Touch Screen 110 is presented with Lock 120 which according to embodiments of the invention provides biometric registration of the user.

Accordingly, the software application for a user providing valid biometric registration credentials determines which user profile of a plurality of user profiles to present to the user. Within this contextual UI mental model 100 the selection therefore is from User Profile A 100A, User Profile B 100B, and User Profile C 100C. If the selection was User Profile A 100A, relating to a first user A, then the user is presented with a contextual dashboard in dependence upon the context of the user at that point in time and their User A Profile 130, being thereby selected from first to third contextual dashboards 140, 142 and 143 respectively. Each of the first to third contextual dashboards 140, 142 and 143 respectively displays a predetermined combination of applications based upon one or more of the characteristics of the selected contextual dashboard, the settings from a previous session, and data retrieved relating to the displayed applications. These applications being selected from first to fifth applications 150 and 152 to 155 respectively.

Where the contextual UI mental model 100 establishes that the user is a second user, User B, then the selected user profile is User Profile B 100B. The presented contextual dashboard selected in dependence upon the context of the user at that point in time and their User B Profile 132, being thereby selected from fourth to sixth contextual dashboards 144 to 146 respectively. Each of the fourth to sixth contextual dashboards 144 to 146 respectively displays a predetermined combination of applications based upon one or more of the characteristics of the selected contextual dashboard, the settings from a previous session, and data retrieved relating to the displayed applications. These applications not displayed for clarity but may include one or more of the first to fifth applications 150 and 152 to 155 respectively as well as others.

If the contextual UI mental model 100 establishes that the user is a third user, User C, then the selected user profile is User Profile C 100C. The presented contextual dashboard selected in dependence upon the context of the user at that point in time and their User Profile C 133 being selected from seventh to ninth contextual dashboards 147 to 149 respectively. Each of the seventh to ninth contextual dashboards 147 to 149 respectively displays a predetermined combination of applications based upon one or more of the characteristics of the selected contextual dashboard, the settings from a previous session, and data retrieved relating to the displayed applications. These applications not displayed for clarity but may include one or more of the first to fifth applications 150 and 152 to 155 respectively as well as others.

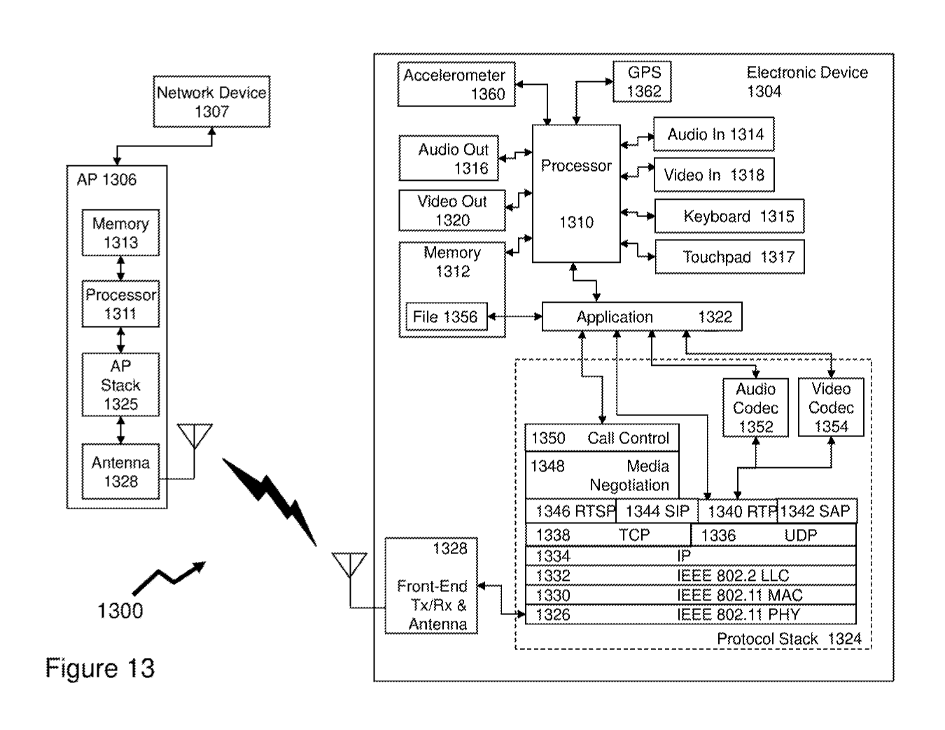

It would be evident to one skilled in the art that the Touch Screen 110 may with variations in Hardware 160 be represented alternatively by one or more user input means and one or more user output means. It would also be apparent that according to the configuration and specifications of elements within the Hardware 160 aspects of the operation and performance of other levels may vary. An exemplary configuration for Hardware 160 is presented below in respect of FIG. 13 by Electronic Device 1304.

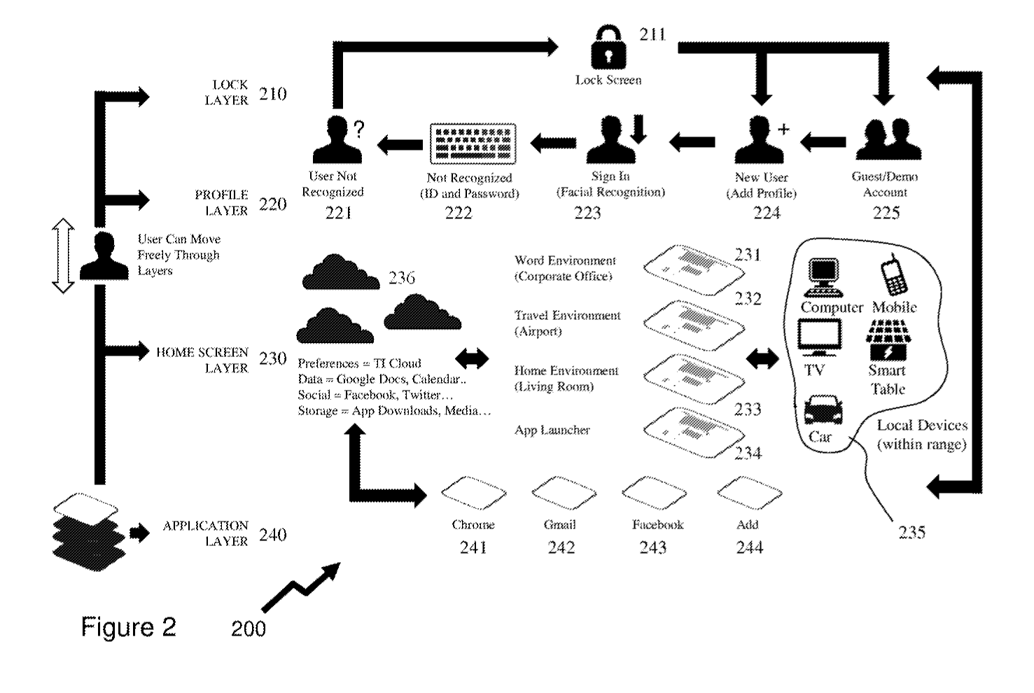

Referring to FIG. 2 there is depicted a contextual UI mental model 200 according to an embodiment of the invention. As shown the contextual UI mental model 200 comprises Lock Layer 210, Profile Layer 220, Contextual dashboard Layer 230, and Application Layer 240. Considering initially Lock Layer 210 then this comprises a Lock Screen 211 that locks the electronic device and requires that a user provide a valid credential or credentials in order to access the Profile Layer 220. Within Profile Layer 220 the contextual UI mental model 200 addresses results of biometric credential provision with Sign In 223 wherein a determination is made as to whether the biometric credential matches an authorized user of the electronic device. If so, the contextual UI mental model 200 proceeds to the Contextual dashboard Layer 230.

If the biometric credential does not match then the contextual UI mental model 200 move to Not Recognized 222 wherein a user may present mechanically entered credentials through providing an ID and associated password. If these credentials are not correct the contextual UI mental model 200 provides a response to the user in User Not Recognized 221 and returns to the Lock Screen 211. At Lock Screen 211 a registered user may elect to add a further user wherein the contextual UI mental model 200 provides for biometric credential registration for the new user in New User 224. Alternatively, the registered user may elect to allow another user to access the electronic device as a temporary user without stored credentials wherein the contextual UI mental model 200 allows for entry through a Guest Account 225.

From either Not Recognized 222 or Sign In 223 the contextual UI mental model 200 proceeds to Contextual dashboard Layer 230. In the instances of New User 224 and Guest Account 225 default contextual dashboards are presented to the user wherein in the former the new user may start the process of establishing characteristics of the contextual dashboard they desire for that current context. Subsequent access by the new user in different contexts will result over time in establishing additional contextual dashboards where appropriate for the user. Within contextual UI mental model 200 there is no customization of contextual dashboard for a guest entering through Guest Account 225.

In Home Layer 230 the selection of a contextual dashboard is made based upon macro-context data, including for example but not limited to electronic device associations, geographic location, network associations, and date and time. As depicted the contextual dashboards are Work Environment 231, Travel Environment 232, and Home Environment 233 as well as an Application Launcher 234 is triggered to launch the applications which will be displayed within the selected contextual dashboard. Each contextual dashboard may be refined based upon micro-context data, including but not limited to electronic device associations, user input, and date and time. Examples of electronic device associations being depicted by device group 235 which includes a computer, a mobile device, television, smart table, an automobile. The Application Launcher 234 launches applications such as Google Chrome 241, Google Gmail 242 and Facebook 243 as well as an interface for adding new applications, Add 244.

Based upon the macro- and micro-context information together with the selected contextual dashboard and launched application data and/or content is retrieved either from within the electronic device supporting the UI or from one or more networks 236 to which the electronic device is connected. Such retrieved data includes user preferences, e.g. using TI Group's TI Cloud services; data source, e.g. Google Does and Calendar; Social networks, e.g. Facebooks and Twitter; and Storage, e.g. Application Downloads and Media sources. Optionally contextual UI mental model 200 may include additional layers to those depicted including but not limited to operating system, hardware, user attributes, user preferences and user input/output devices.

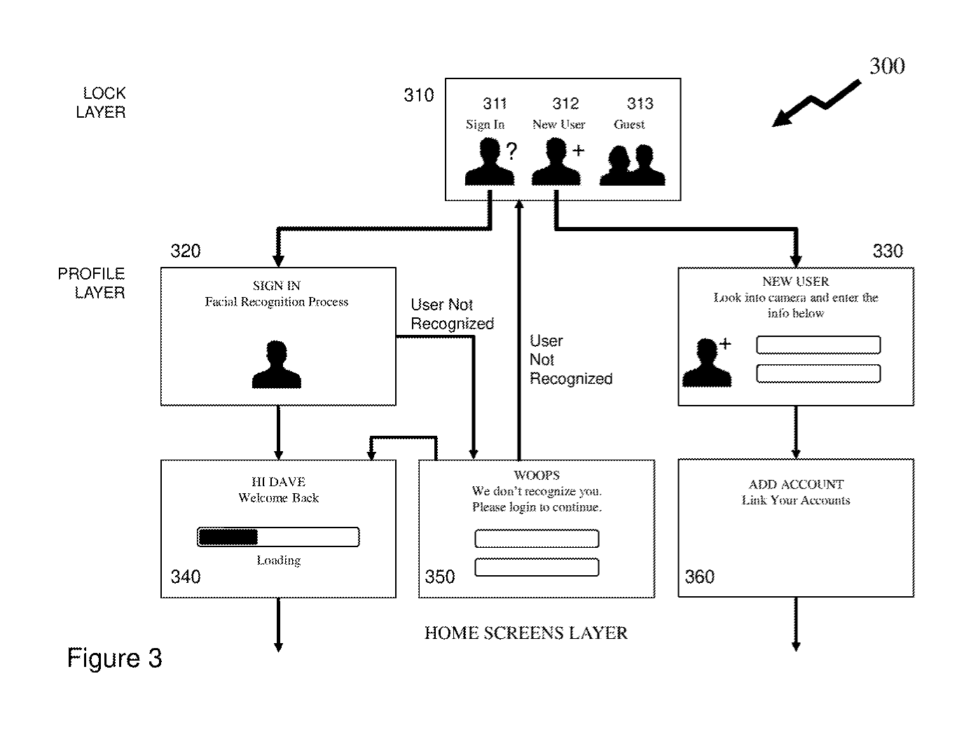

Now referring to FIG. 3 there is depicted an exemplary profile layer flow 300 according to an embodiment of the invention wherein biometric credential entry is through facial recognition. Accordingly, at Lock Layer 310 responses to biometric credential and/or other data entry is determined as Sign In 311, New User 312, and Guest 313. From Sign In 311 the process flow proceeds to Profile Layer with Facial Recognition Sign In 320 wherein the user is either recognized leading to progression to Welcome 340 or not recognized leading to Woops 350 wherein alternate credential entry is provided to the user. For example, the user may be in different lighting conditions, wearing clothing partially obscuring their face, etc. which causes the facial recognition process to fail even for an authorized user. Successful entry of the alternate credentials in Woops 350 leads to Welcome 340 otherwise the flow returns to Lock Layer 310. From New User 312 the flow proceeds to Face Entry 330 wherein the new user is asked to look into the camera to allow an image to be captured for processing and storage as a new authorized facial credential. From New User 312 the flow proceeds to Add Account 360 wherein the new user is prompted to link predetermined applications within the default contextual dashboard(s) to their personal accounts, such as Twitter™, Facebook™, Gmail™, and LinkedIn™. From Add Account 360 and Welcome 340 the flow proceeds to the Contextual dashboards Layer which is not shown for clarity.

It would be evident to one skilled in the art that facial recognition represents only one potential biometric verification technique available. Any biometric identifier which is a distinctive, measurable characteristic used to differentiate individuals may be employed and are generally categorized as physiological or behavioral characteristics. Physiological characteristics are related to the shape of the body, and include but are not limited to, fingerprint, face recognition, DNA, palm print, hand geometry, iris recognition, retina recognition, DNA, and odour/scent. Behavioral characteristics include but not limited to typing rhythm, gait, and voice. It would be evident to one skilled in the art that the selected biometric characteristic may be selected according to the electronic device, the degree of security protection required, etc. and that in other instances two or more biometric characteristics may be employed.

One potential disadvantage of some biometrics, such as facial recognition which is common due to smartphones and cellular telephones, laptops, tablet computers, etc. including a camera, is that if someone's face is compromised that it cannot be cancelled and re-issued unlike a token or password. Accordingly, embodiments of the invention may employ cancelable biometrics wherein protection is incorporated or replacement features are included. For example, cancelable biometrics may perform a distortion of the biometric image or features before matching and it is the variability in the distortion parameters which provides the cancelable nature of the scheme.

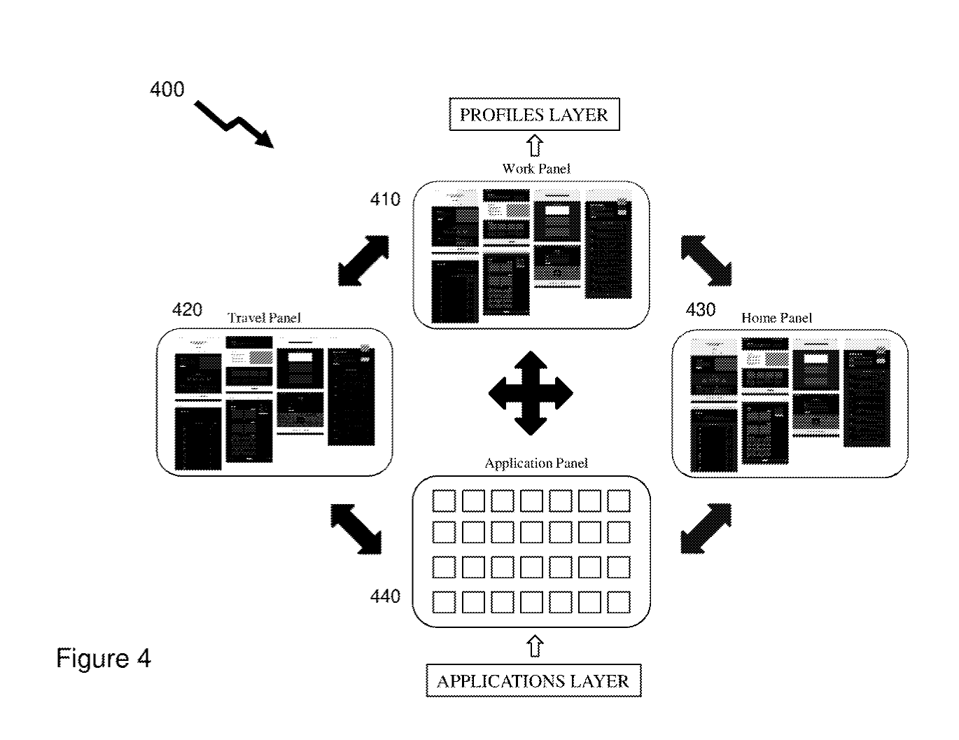

Referring to FIG. 4 there is depicted an exemplary migration of contextual dashboard layers for a user according to an embodiment of the invention within flow 400. Accordingly, within a contextual dashboard layer of a contextual UI four contextual dashboards are Work Panel 410, Travel Panel 420, Home Panel and Application Panel 440. Migration between any pair of contextual dashboards may be made either through the user ceasing to use the UI and re-accessing the lock screen from a different location or as the result of continued use with migration from one macro-context to another. Likewise, the Application Panel 440 may be accessed from any home panel. Optionally, Application Panel 440 may be accessible only from a limited number of macro-context defined home panels.

Alternatively, where a user is accessing one or more applications during the detection of a macro-context and/or micro-context change these applications may be maintained in the initial configuration until a predetermined condition occurs such as stopping the application, inactivity for predetermined period of time, or an override resulting from preferences and/or settings may be invoked.

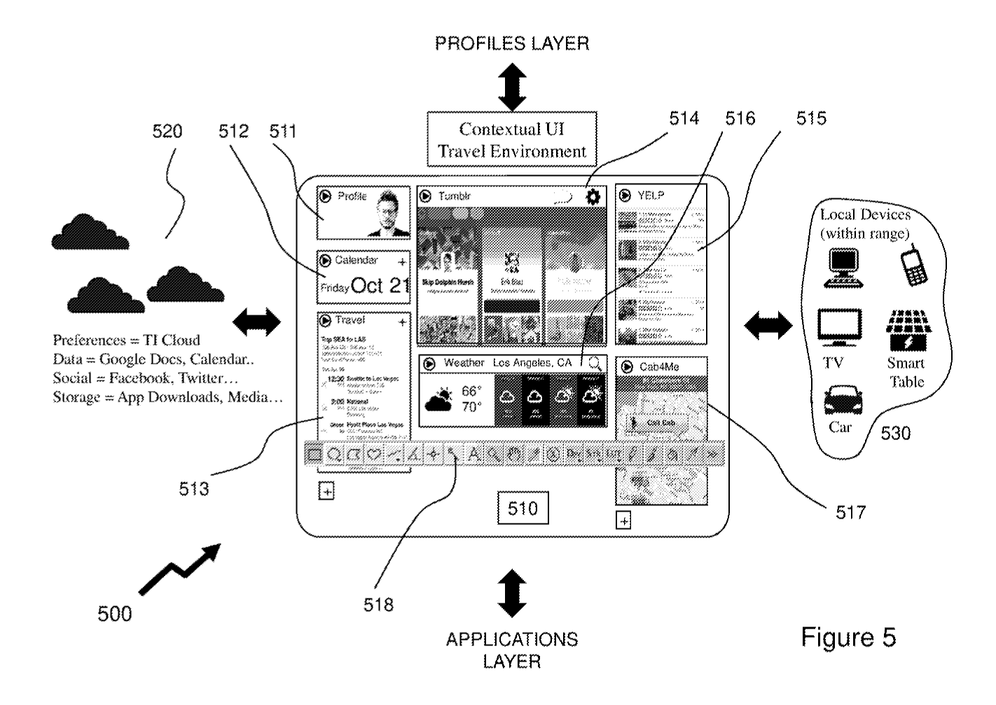

Now referring to FIG. 5 there is depicted an exemplary contextual dashboard 510 for a UI 500 wherein the macro-context is travel as presented to a user according to an embodiment of the invention. Accordingly, contextual dashboard 510 sits between the profiles layer and applications layer of the UI 500 and has been established in dependence upon macro-context, not shown for clarity, and micro-context information 530. Data and content for the applications within contextual dashboard 510 being sourced from the electronic device and/or through remote sources 520 interfaced through one or more networks connected to the electronic device. Depicted within contextual dashboard 510 are applications for Profile 511, Calendar 512, Travel 513, Blog 514, Review 515, Weather 516, Taxi 517 as well as toolbar 518. Travel 513 may for example be TripIt™, Weather 516 AccuWeather, Blog 514 Tumblr™, Review 515 Yelp™ and Taxi 517 Cab4Me™.

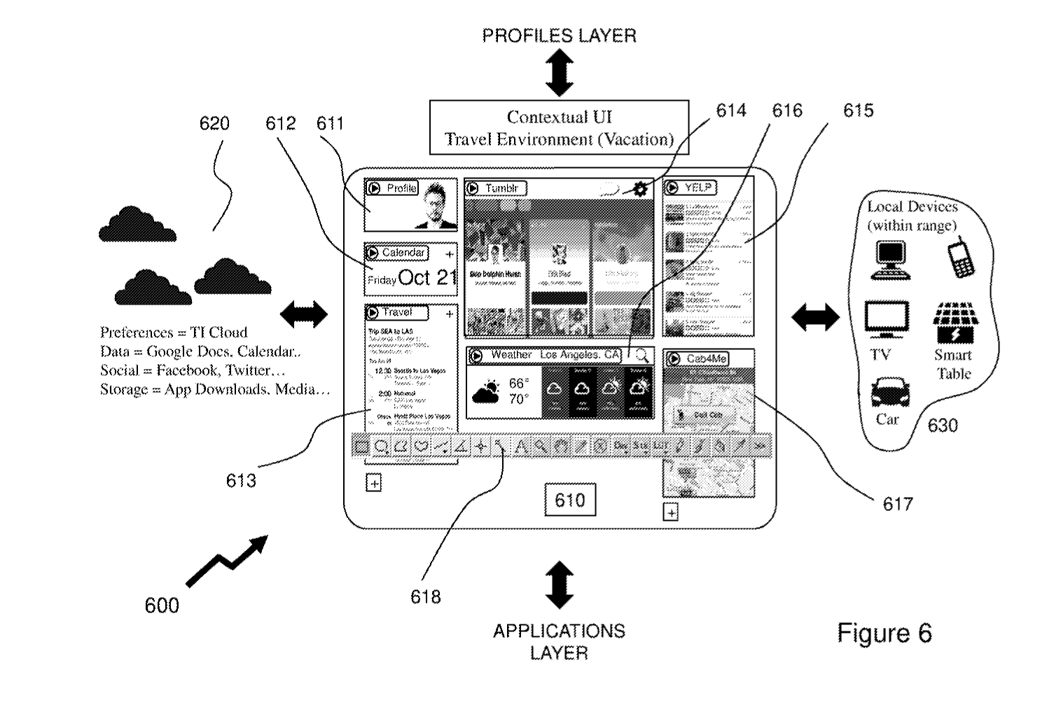

Now referring to FIG. 6 there is depicted an exemplary contextual dashboard 610 for a UI 800 wherein the macro-context is travel as presented to a user according to an embodiment of the invention but wherein the context is now one of vacation as opposed to business travel. Accordingly, contextual dashboard 610 sits between the profiles layer and applications layer of the UI 600 and has been established in dependence upon macro-context, not shown for clarity, and micro-context information 630. Data and content for the applications within contextual dashboard 610 being sourced from the electronic device and/or through remote sources 620 interfaced through one or more networks connected to the electronic device. Depicted within contextual dashboard 610 are applications for Profile 611, Calendar 612, Travel 613, Blog 614, Review 615, Weather 616, Taxi 617 as well as toolbar 618. It would be evident to one skilled in the art that the applications displayed within the UI in the travel and travel (vacation) contextual dashboards may be different as well as having different settings/preferences.

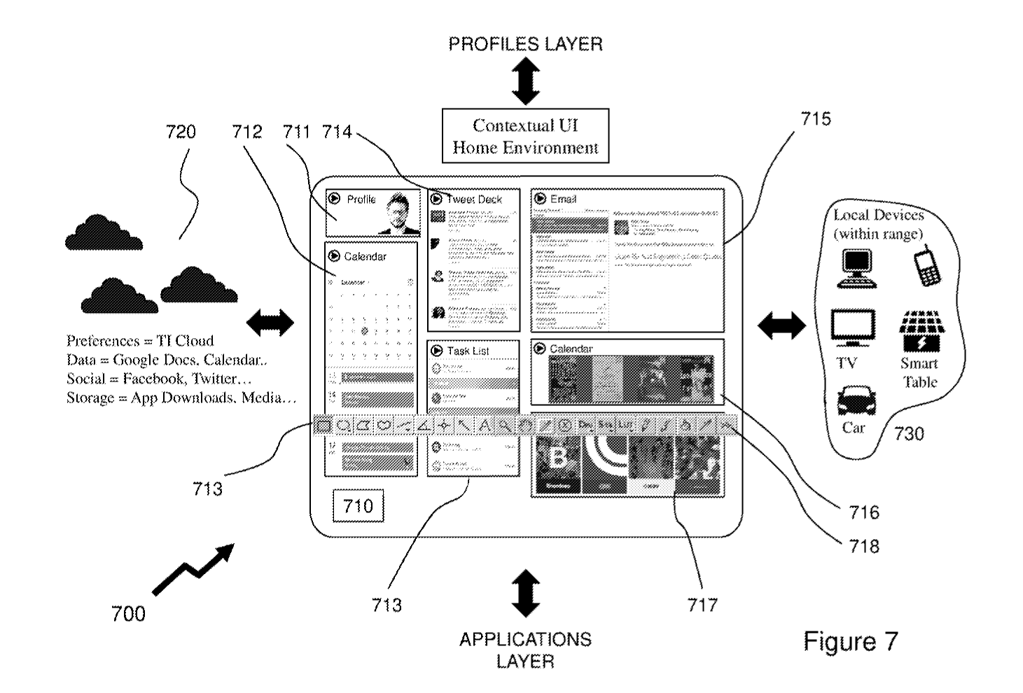

Now referring to FIG. 7 there is depicted an exemplary contextual dashboard 710 for a UI 700 wherein the macro-context is work as presented to a user according to an embodiment of the invention. Accordingly, contextual dashboard 710 sits between the profiles layer and applications layer of the UI 700 and has been established in dependence upon macro-context, not shown for clarity, and micro-context information 730. Data and content for the applications within contextual dashboard 710 being sourced from the electronic device and/or through remote sources 720 interfaced through one or more networks connected to the electronic device. Depicted within contextual dashboard 710 are applications for Profile 711, Calendar 712, Task List 714, Social Application 713, Email 715, eReader 716, News 717 as well as toolbar 718. Calendar 712 and Task 714 for example being Google Calendar and task list within Google Calendar, Social Application 713 for example being Tweet Deck, Email 715 for example being Google Gmail, eReader 716 for example being Kindle™ Reader, and News 717 being Yahoo™ News.

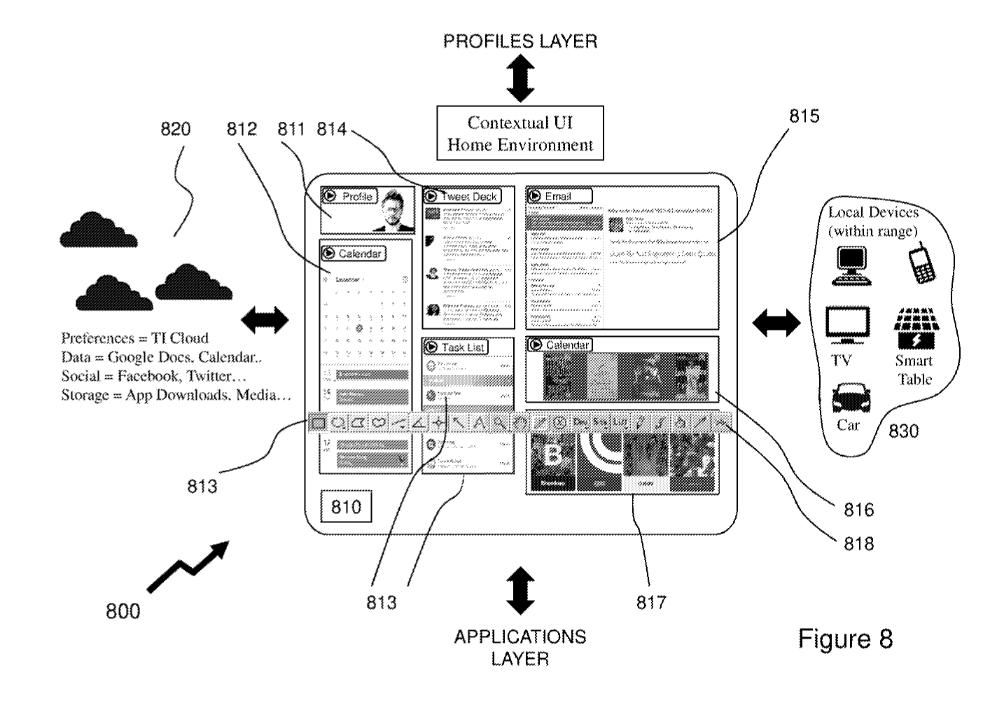

Now referring to FIG. 8 there is depicted an exemplary contextual dashboard 1310 for a UI 800 wherein the macro-context is work as presented to a user according to an embodiment of the invention but now applications are shown with task modes active. Accordingly, contextual dashboard 810 sits between the profiles layer and applications layer of the UI 800 and has been established in dependence upon macro-context, not shown for clarity, and micro-context information 830. Data and content for the applications within contextual dashboard 810 being sourced from the electronic device and/or through remote sources 820 interfaced through one or more networks connected to the electronic device. Depicted within contextual dashboard 810 are applications for Profile 811, Calendar 812, Task List 814, Social Application 813, Email 815, eReader 816, News 817 as well as toolbar 818. Calendar 812 and Task 814 for example being Google Calendar and task list within Google Calendar, Social Application 813 for example being Tweet Deck, Email 815 for example being Google Gmail, eReader 816 for example being Kindle™ Reader, and News 817 being Yahoo™ News. Tasks within the task bars being:
Profile 811—Switch User, Lock;
Calendar 812—View, Add Event;
Social Application 813—On, My Tweets, Friends;
Task 814—All, Open, Closed;
Email 815—Inbox, Set, Drafts, Trash;
eReader 816—Recent, Title, Author; and
News 817—Top Stories, Videos.

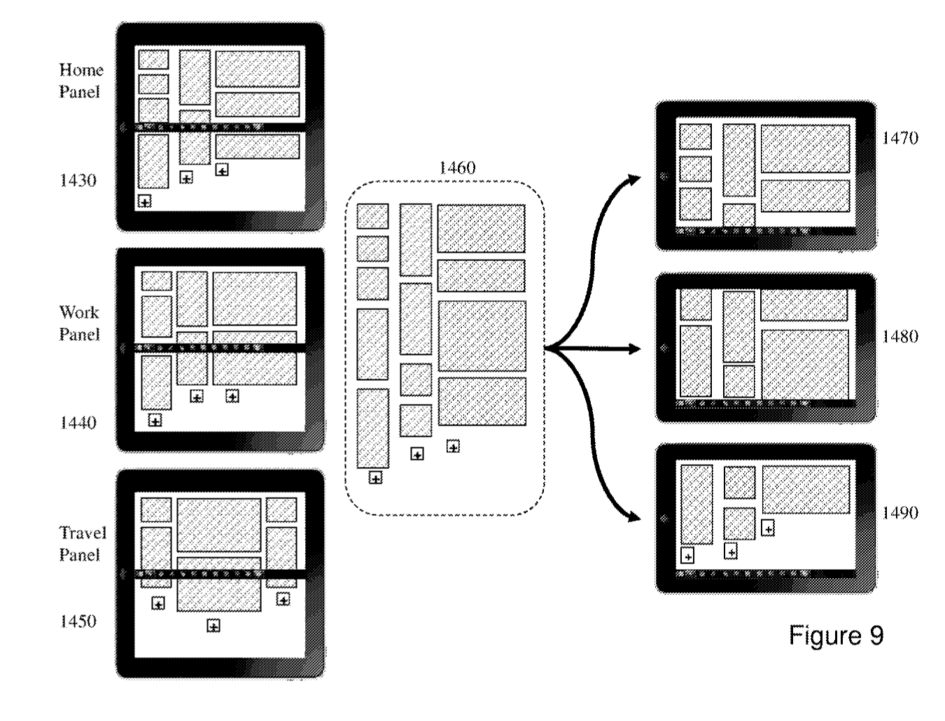

Now referring to FIG. 9 are examples of layouts for a user wherein they have configured Home Panel 930, Work Panel 940, and Travel Panel 950. It would be evident to one skilled in the art that a new user may initially be presented with default screens for multiple contextual dashboards or may be presented with a single contextual dashboard and then given the option to establish subsequent contextual dashboards through a user driven process. Optionally, the UI may be monitoring macro- and micro-context information and may derive based upon a pattern of behavior that the user may benefit from the addition of a new screen. For example, the UT may note that the user accesses Microsoft Outlook between 10 am and 4 pm weekdays alongside Google Calendar in association with an IEEE 802.11g node identified as “USPTO ABC123” whilst their initially configured contextual dashboard is Google Gmail and Google Calendar in association with an IEEE 802.11b node identified as “RobinsonFamily.” Accordingly, the UI may prompt the user as to whether they wish to assign a new contextual dashboard, select the contextual dashboard definition (e.g. work, main office etc.) and then store their current application settings as part of that new contextual dashboard.

Also depicted in FIG. 9 is a contextual dashboard 960 wherein the user has added a large number of applications to the one contextual dashboard. Accordingly, in first screen 970 the user is presented with a top portion of the contextual dashboard 960 that maps to the electronic device display based upon user preferences, such as for example minimum font size. If the user scrolls down then the display adjusts to present second screen 980, and then subsequently third screen 990 as the user keeps scrolling. As displayed within first to third screens 970 to 990 respectively the UI manages the application so that these are displayed within the screen as full windows and accordingly the relative position of applications within each of the first to third screens 970 to 990 adjusts relative to the mapped application structure in contextual dashboard 960. Similarly, rotating the screen of the electronic device would result in a different mapping of the contextual dashboard 960 to displayed screens to the user.

It would be evident that the user may in addition to having home, work, and travel as contextual dashboard options may establish multiple contextual dashboards for work for example to reflect their activities within their office versus those in the boardroom as micro-context driven work contextual dashboard variations. Similarly, a user may have multiple contextual dashboards for their home such as office, playroom, living room, bedroom and may optionally also opt to configure multiple contextual dashboards for the same macro- and micro-context. For example, their contextual dashboard for “home” and “office” may be configured to one contextual dashboard during 8 am-6 pm Monday-Friday and configured to another contextual dashboard during other times. In this example the macro- and micro-context now includes overall geographic location, electronic association to define office as opposed to kitchen etc., and time-day to provide multiple contextual dashboards in the same physical location.

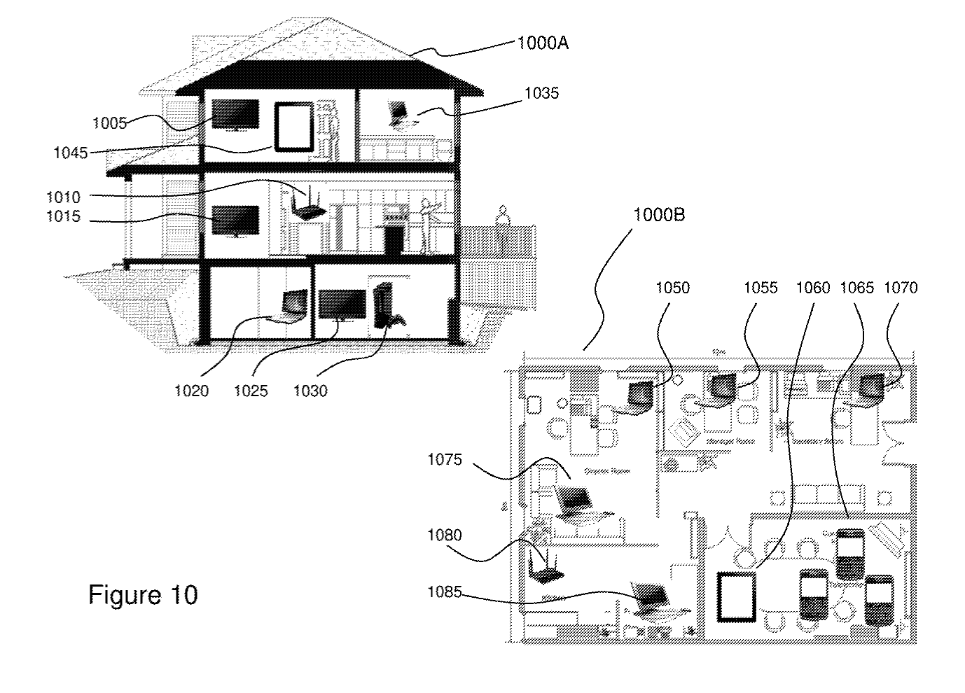

Now referring to FIG. 10 there are depicted residential and office environments 1000A and 1000B respectively and elements within these that provide micro-contexts for UIs according to embodiments of the invention. Accordingly, residential environment 1000A comprises a plurality of rooms within one of which is Wi-Fi node 1010 and typically as single Wi-Fi node 1010 will cover a single residential environment 1000A and further as most residential users can see multiple local residential Wi-Fi nodes within urban environments. Accordingly Wi-Fi node 1020 when associated to a tablet 1045 would allow the UI to establish the macro-context as “home” but nothing more. Within the residential environment 1000A are first to third televisions 1005, 1015, and 1025 respectively within a bedroom, living room and basement playroom; gaming console 1030 in the basement, laptop within basement office, and laptop 1035 within another bedroom. Accordingly, the tablet 1045 may establish associations with these other electronic devices in order to refine the macro-context to a micro-context.

For example, if the tablet 1045 associates with first television 1005 then the user will be close to the bedroom whereas if it associates to third television 1025 and gaming console 1030 then it is close to the basement playroom. If the associations include device identities which are verified by the user then only an association with one of the three televisions is sufficient. For example, the user is in the basement and the UI is triggered by the user or triggers for the user a new contextual dashboard process then when the association to the third television 1025 is made the identity is stored as part of the micro-context. Accordingly, if the gaming console 1030 is absent or unpowered then the micro-context for the “basement playscreen” contextual dashboard does not require detection of both the third television 1025 and gaming console 1030.

It would be evident to one skilled in the art that the tablet 1045 may associate with both first and second televisions 1005 and 1015 due to the range of the Wi-Fi (IEEE 802.11)/WiMAX (IEEE 802.16) wireless transmitters and receivers. Accordingly, the UI may selectively control the wireless transmitter within the tablet 1045 to reduce the range of the wireless transmitter, e.g. IEEE 802.11 Wi-Fi until the electronic associations are reduced to a level such that only those elements within the immediate vicinity rather than the entire residential environment and/or neighbourhood are identified as part of the wireless environment. Alternatively, the micro-context determination may exploit IEEE 802.15 or Bluetooth as a shorter range wireless interface to establish micro-context with IEEE 802.11/802.16 Wi-Fi/WiMAX for macro-context.

Referring to commercial environment 1000B a small office configuration is laid out comprising offices with first and second desktops 1075 and 1085 and first to third laptops 1055, 1070, and 1050 which are interfaced to Wi-Fi node 1080. Accordingly, the user's tablet 1060 may be configured to establish a contextual dashboard to work based upon an association with the Wi-Fi node 1080. Micro-contexts may for example be triggered through an association of the tablet 1060 to first laptop 1050 as putting the user within their office but an association establishing multiple unknown smartphones 1065 may establish a micro-context of the meeting room (boardroom).

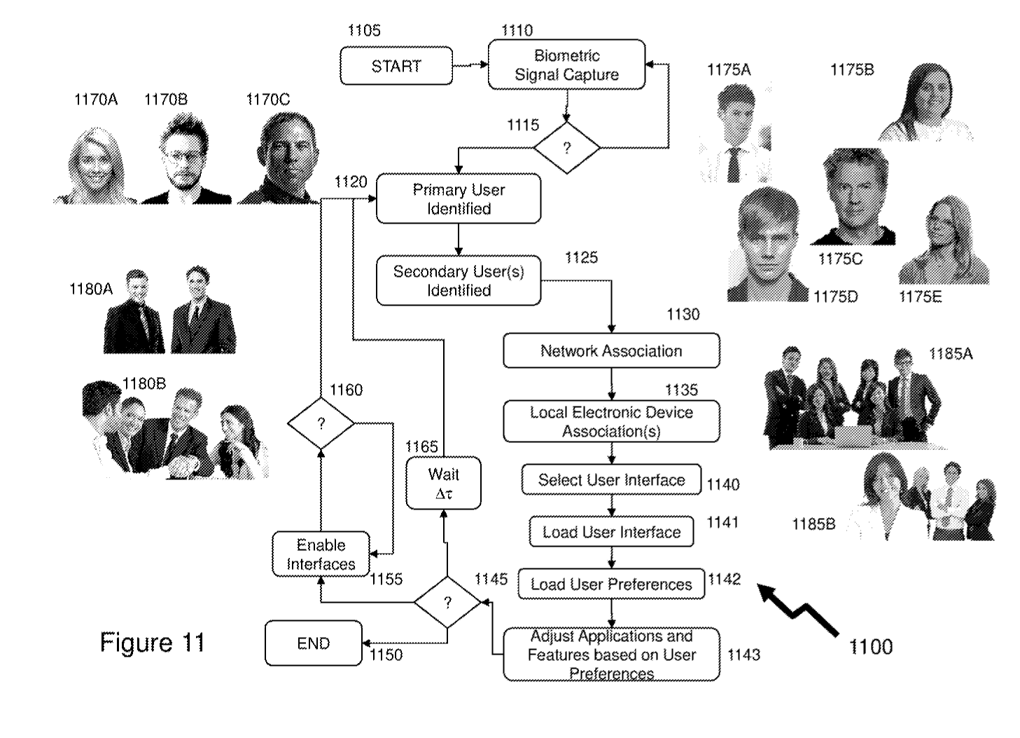

Now referring to FIG. 11 there is depicted an exemplary process flow 1100 for user and context determination of macro- and micro-context factors according to an embodiment of the invention for a portable electronic device (PED). Accordingly, the process begins at step 1100 where a user picks up the PED and the UI receives accelerometer data which is used to trigger the UI to enter the lock screen from a sleep mode wherein in step 1110 a user provides the biometric input which is evaluated in step 1115 to determine whether the user is authorised. An example of steps 1110 and 1115 is presented above in respect of FIG. 3. In step 1120 the UI determines identity of the primary user for whom biometric verification was obtained and then proceeds in step 1125 to determine whether secondary users are present. For example the UI may analyse the remainder of the image taken for a facial recognition of the user to determine whether there are other individuals in the image as well as receiving additional input such as audio to form part of the determination of secondary users.

Next in step 1130 the UI proceeds to determine network associations for the PED and then local electronic device associations in step 1135. These are all used in conjunction with primary and secondary user data and other contextual information including, but not limited to, GPS data, accelerometer data, date, time, background of image (where facial recognition is employed) in step 1140 to determine the contextual dashboard to be employed. This is then loaded in step 1141 wherein the UI proceeds to load the user preferences associated with the selected dashboard of the plurality of available dashboards. Next in step 1143 the UI adjusts the features of the applications and the applications based upon the user preferences. For example, where the user is identified to be “Tom” working at their office then the email application opened is Microsoft Outlook and the preferences are their user name and password but where it is determined “Tom” is at home then the application may be Google Gmail and no preferences are used.

Next in step 2745 the process determines whether the UI is established in periodic or single access mode, the former relating to periodic verification of the macro- and micro-context information and the latter to no subsequent verification until a timeout or other condition is met and the screen locks. If the latter the process moves to step 1150 and stops, otherwise it proceeds to step 1155 wherein periodic verification is to be based upon environmental data or step 1165 wherein the periodic verification is based upon a time interval, Ar. If the process proceeds on time interval basis then after a delay of Az⁻ the process moves to step 1120. If based on environmental data then the PED enables interfaces in step 1155 and looks for additional user characteristics in step 1160 wherein absence results in the process looping back to step 1155 and presence results in the process proceeding back to step 1120.

It would be evident that rather than proceeding to loop back to step 1120 that the process may alternatively loop back to step 1110 and repeat biometric verification. Optionally this pauses all applications until verification is provided, such as with a fingerprint and facial recognition, or without pause wherein a verification may be processed without disrupting the user's activity such as with facial recognition. Accordingly, biometric verification may be allowed on the electronic device for first to fifth family members 1175A through 1175E representing a father, mother, son, daughter, and grandfather and first to third staff 1170A through 1170C representing work colleagues. Optionally a user, such as father, being first family member 1175A may appear in both and hence second staff 1170B may also be the same individual. As such the primary user would be selected from first to fifth family members 1175A through 1175E and first to third staff 1170A through 1170C.

Secondary users may be identified from the unlock sequence, such as within the image captured for facial recognition or through interfaces on the PED such as the microphone during operation of the PED with the UI unlocked so that these are captured in the absence of electronic device associations with the secondary user's PEDs or FEDs. It would be evident that secondary user is a broad term in this context as these individuals may not be actually using the PED but are within the micro-environment of the user and hence impact the micro-context. For example, an adult user unlocking the PED may establish Google Image searches to be unrestricted on content but this may be inappropriate where the secondary users are present such as work colleagues, as depicted in first and second work groups 1180A and 1180B or children as depicted in first and second family groups 1185A and 281513 respectively.

It would be evident to one skilled in the art that based upon the macro- and micro-context aspects of the UI that the lock in screen may be similarly considered a contextual dashboard such that first and third staff 1170A and 1170C may only unlock the PED according to an embodiment of the invention when the macro- and micro-context select a contextual dashboard having them as authorized users. Accordingly, a manager may authorize their administration assistant to access their PED at work, no one else in travel mode, and their family when the PED is at home. Accordingly, the manager may have full access rights to certain applications and their administration assistant limited access rights to those applications and his family no access rights. Similarly, the user's family would be unable to unlock the PED at the user's office and perhaps only the adults the PED in travel mode to limit children playing with it.

It would be evident to one skilled in the art how evolution of the micro-context concept may be evolved from one wherein these are statically allocated at user log-in to one wherein they are allocated dynamically in dependence upon the actual environment. For example the following scenarios relating to dynamically assigned contextual dashboards may be implemented according to embodiments of the invention:
User A logs-in and UI establishes a contextual dashboard but they pass the PED to another user, User B, who now has access to the User A contextual dashboard plus preferences, accordingly the UI is monitoring periodically taken digital images and notes the user change and swaps to either User B contextual dashboard where recognised user or guest screen;
User A logs-in and UI establishes a contextual dashboard but now the user puts the device down onto to a table and hence they are now no linger visible if the UI is checking image but their speech is now recognised and the UI maintains the current contextual dashboard;
User A logs-in and UI establishes a contextual dashboard but now UI detects another individual behind User A and adjusts the contextual dashboard or closes it down and warns User A;
User A logs-in and UI establishes a first contextual dashboard but now User A moves with the PED and maintains activity with it and User A now enters another recognized micro- and macro-context environment such that the UI now changes the contextual dashboard from the original context to the new context, where such changes may be evolved slowly such that for example applications currently not in use are adjusted immediately but those in use are maintained or gradually adjusted where possible;
User A logs-in and UI establishes a contextual dashboard with the user displaying content on another display associated with the PED and the PED display is presenting a large keyboard, the user then moves and the UI automatically updates the contextual dashboard such that the content is now presented to the user on their PED seamlessly and the keyboard is reduced to that normally presented to the user on the PED.

It would be evident to one skilled in the art that UI contextual dashboards according to embodiments of the invention by providing macro-context and micro-context variations where selected by the user provide for a dynamic migration of the UI according to the user's activities and schedule. How many contextual dashboards a user establishes is their personal preference although a PED or FED may provide initially a limited number of default contextual dashboards for configuration. In other embodiments of the invention the UI correlates and samples macro-context and micro-context information to determine whether a user may benefit from another contextual dashboard in addition to those currently established.

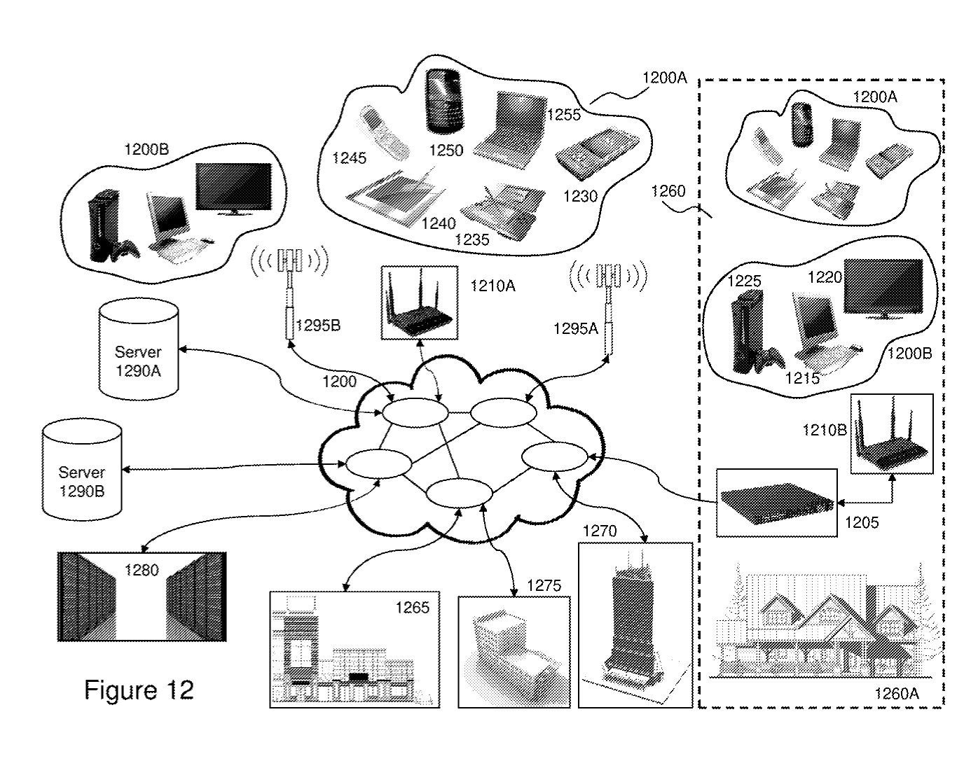

Now referring to FIG. 12 there is depicted a network 1200 supporting communications to and from electronic devices implementing contextual based UIs according to embodiments of the invention. As shown first and second user groups 1200A and 1200B respectively interface to a telecommunications network 1200. Within the representative telecommunication architecture a remote central exchange 1280 communicates with the remainder of a telecommunication service providers network via the network 1200 which may include for example long-haul OC-48/OC-192 backbone elements, an OC-48 wide area network (WAN), a Passive Optical Network, and a Wireless Link. The central exchange 1280 is connected via the network 1200 to local, regional, and international exchanges (not shown for clarity) and therein through network 1200 to first and second wireless access points (AP) 1295A and 1295B respectively which provide Wi-Fi cells for first and second user groups 1200A and 1200B respectively. Also connected to the network 1200 are first and second Wi-Fi nodes 1210A and 1210B, the latter of which being coupled to network 1200 via router 1205. Second Wi-Fi node 1210B is associated with residential building 1260A and environment 1260 within which are first and second user groups 1200A and 1200B. Second user group 1200B may also be connected to the network 1200 via wired interfaces including, but not limited to, DSL, Dial-Up, DOCSIS, Ethernet, G.hn, ISDN, MoCA, PON, and Power line communication (PLC) which may or may not be routed through a router such as router 1205.

Within the cell associated with first AP 1210A the first group of users 1200A may employ a variety of portable electronic devices including for example, laptop computer 1255, portable gaming console 1235, tablet computer 1240, smartphone 1250, cellular telephone 1245 as well as portable multimedia player 1230. Within the cell associated with second AP 1210B are the second group of users 1200B which may employ a variety of fixed electronic devices including for example gaming console 1225, personal computer 1215 and wireless/Internet enabled television 1220 as well as cable modem 1205.

Also connected to the network 1200 are first and second APs which provide, for example, cellular GSM (Global System for Mobile Communications) telephony services as well as 3G and 4G evolved services with enhanced data transport support. Second AP 1295B provides coverage in the exemplary embodiment to first and second user groups 1200A and 1200B. Alternatively the first and second user groups 1200A and 1200B may be geographically disparate and access the network 1200 through multiple APs, not shown for clarity, distributed geographically by the network operator or operators. First AP 1295A as show provides coverage to first user group 1200A and environment 1260, which comprises second user group 1200B as well as first user group 1200A. Accordingly, the first and second user groups 1200A and 1200B may according to their particular communications interfaces communicate to the network 1200 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-2000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 1200A may form associations either through standards such as IEEE 802.15 and Bluetooth as well in an ad-hoc manner.

Also connected to the network 1200 are retail environment 1265, first commercial environment 1270, and second commercial environment 1275 as well as first and second servers 1290A and 1290B which together with others not shown for clarity, may host according to embodiments of the inventions multiple services associated with a provider of the software operating system(s) and/or software application(s) associated with the electronic device(s), a provider of the electronic device, provider of one or more aspects of wired and/or wireless communications, product databases, inventory management databases, retail pricing databases, license databases, customer databases, websites, and software applications for download to or access by fixed and portable electronic devices. First and second primary content sources 1290A and 1290B may also host for example other Internet services such as a search engine, financial services, third party applications and other Internet based services.

FIG. 13 there is depicted an electronic device 1304 and network access point 1307 supporting contextual based UIs according to embodiments of the invention. Electronic device 1304 may for example be a portable electronic device or a fixed electronic device and may include additional elements above and beyond those described and depicted. Also depicted within the electronic device 1304 is the protocol architecture as part of a simplified functional diagram of a system 1300 that includes an electronic device 1304, such as a smartphone 1255, an access point (AP) 1306, such as first Wi-Fi AP 610, and one or more network devices 1307, such as communication servers, streaming media servers, and routers for example such as first and second servers 175 and 185 respectively. Network devices 1307 may be coupled to AP 1306 via any combination of networks, wired, wireless and/or optical communication links such as discussed above in respect of FIG. 1. The electronic device 1304 includes one or more processors 1310 and a memory 1312 coupled to processor(s) 1310. AP 1306 also includes one or more processors 1311 and a memory 1313 coupled to processor(s) 1311. A non-exhaustive list of examples for any of processors 1310 and 1311 includes a central processing unit (CPU), a digital signal processor (DSP), a reduced instruction set computer (RISC), a complex instruction set computer (CISC) and the like. Furthermore, any of processors 1310 and 1311 may be part of application specific integrated circuits (ASICs) or may be a part of application specific standard products (ASSPs). A non-exhaustive list of examples for memories 1312 and 1313 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic device 1304 may include an audio input element 1314, for example a microphone, and an audio output element 1316, for example, a speaker, coupled to any of processors 1310. Electronic device 1304 may include a video input element 1318, for example, a video camera, and a video output element 1320, for example an LCD display, coupled to any of processors 1310. Electronic device 1304 also includes a keyboard 1315 and touchpad 1317 which may for example be a physical keyboard and touchpad allowing the user to enter content or select functions within one of more applications 1322. Alternatively, the keyboard 1315 and touchpad 1317 may be predetermined regions of a touch sensitive element forming part of the display within the electronic device 1304. The one or more applications 1322 that are typically stored in memory 1312 and are executable by any combination of processors 1310. Electronic device 1304 also includes accelerometer 1360 providing three-dimensional motion input to the process 1310 and GPS 1362 which provides geographical location information to processor 1310.

Electronic device 1304 includes a protocol stack 1324 and AP 1306 includes a communication stack 1325. Within system 1300 protocol stack 1324 is shown as IEEE 802.11 protocol stack but alternatively may exploit other protocol stacks such as an Internet Engineering Task Force (IETF) multimedia protocol stack for example. Likewise, AP stack 1325 exploits a protocol stack but is not expanded for clarity. Elements of protocol stack 1324 and AP stack 1325 may be implemented in any combination of software, firmware and/or hardware. Protocol stack 1324 includes an IEEE 802.11-compatible PHY module 1326 that is coupled to one or more Front-End Tx/Rx & Antenna 1328, an IEEE 802.11-compatible MAC module 1330 coupled to an IEEE 802.2-compatible LLC module 1332. Protocol stack 1324 includes a network layer IP module 1334, a transport layer User Datagram Protocol (UDP) module 1336 and a transport layer Transmission Control Protocol (TCP) module 1338.

Protocol stack 1324 also includes a session layer Real Time Transport Protocol (RTP) module 1340, a Session Announcement Protocol (SAP) module 1342, a Session Initiation Protocol (SIP) module 1344 and a Real Time Streaming Protocol (RTSP) module 1346. Protocol stack 1324 includes a presentation layer media negotiation module 1348, a call control module 1350, one or more audio codecs 1352 and one or more video codecs 1354. Applications 1322 may be able to create maintain and/or terminate communication sessions with any of devices 1307 by way of AP 1306. Typically, applications 1322 may activate any of the SAP, SIP, RTSP, media negotiation and call control modules for that purpose. Typically, information may propagate from the SAP, SIP, RTSP, media negotiation and call control modules to PHY module 1326 through TCP module 1338, IP module 1334, LLC module 1332 and MAC module 1330.

It would be apparent to one skilled in the art that elements of the electronic device 1304 may also be implemented within the AP 1306 including but not limited to one or more elements of the protocol stack 1324, including for example an IEEE 802.11-compatible PHY module, an IEEE 802.11-compatible MAC module, and an IEEE 802.2-compatible LLC module 1332. The AP 1306 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module.

Portable and fixed electronic devices represented by electronic device 1304 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-2000, DSL, Dial-Up, DOCSIS, Ethernet, G.hn, ISDN, MoCA, PON, and Power line communication (PLC).

It would be evident to one skilled in the art that the number of contextual dashboards may be limited for some users, wherein in fact the UI essentially provides only a single contextual dashboard, and be significant for others who may have multiple contextual dashboards associated with home, work, recreation, travel etc. for themselves and that these may be present for others within their family. Accordingly, a tablet for a family of four, two adults and two children, may have the following 12 contextual dashboards:
Home=7, a macro-context associated with each member of the family plus micro-contexts associated for each adult working at home, plus 1 micro-context for the adults removing parental controls for their bedroom;
School=2, a macro-context associated with each child;
Work=2, a macro-context associated with each adult; and
Travel=1, a macro-context associated with all family members.

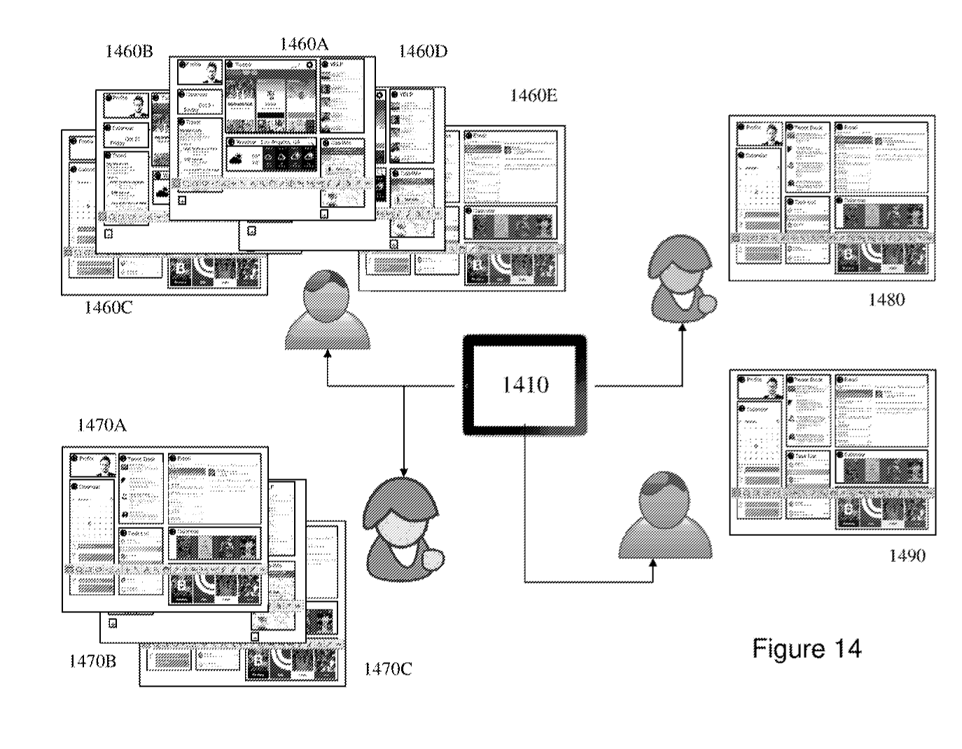

Referring to FIG. 14 there is depicted a PED 1410 having multiple associated users within a family each with user customized contextual based UI dashboards according to an embodiment of the invention. Accordingly, first to fourth users 1420 through 1450 each have associated with their user account one or more dashboards. First user 1420, for example the father-husband, has first to fifth UI dashboards 1460A through 1460E which may relate, for example, to work and home contextually established user customized dashboards such as described above in respect of FIGS. 1 through 11. Second user 1440, for example the mother wife, has sixth to eighth UI dashboards 1470A through 1470C respectively which may relate, for example, to home contextually established user customized dashboards such as described above in respect of FIGS. 1 through 11. Third and fourth users 1430 and 1450 respectively, for example a daughter and son, have ninth and tenth UI dashboards 1480 and 1490 respectively which each relate for example to home user customized dashboards such as described above in respect of FIGS. 1 through 11 but without contextual variations. This ability having been restricted by the parents although optionally in other situations each of third and fourth users 1430 and 1450 respectively may have different levels of access to contextual dashboard customization.

Accordingly, when the PED 1410 is replaced by this family, either as the result of an upgrade to another PED, replacement through loss, or replacement through defect then all of these user customized contextual and non-contextual UI dashboards are lost requiring the users to re-establish them on the new PED. Similarly, if one user, e.g. first user 1420 acquires another PED they must re-establish their user customized contextual and non-contextual UI dashboards on the new PED. Alternatively, a user, e.g. first user, may have two PEDs and due to circumstances, e.g. taking the incorrect PED or losing one PED, may have taken the PED with their home contextual UI dashboards to their work wherein the work contextual UI dashboards they normally use are now unavailable to them. Irrespective of the root cause it would be evident that in each such instance the user or users must expend valuable time to establish these contextual and non-contextual UI dashboards on either the new or alternative PED.

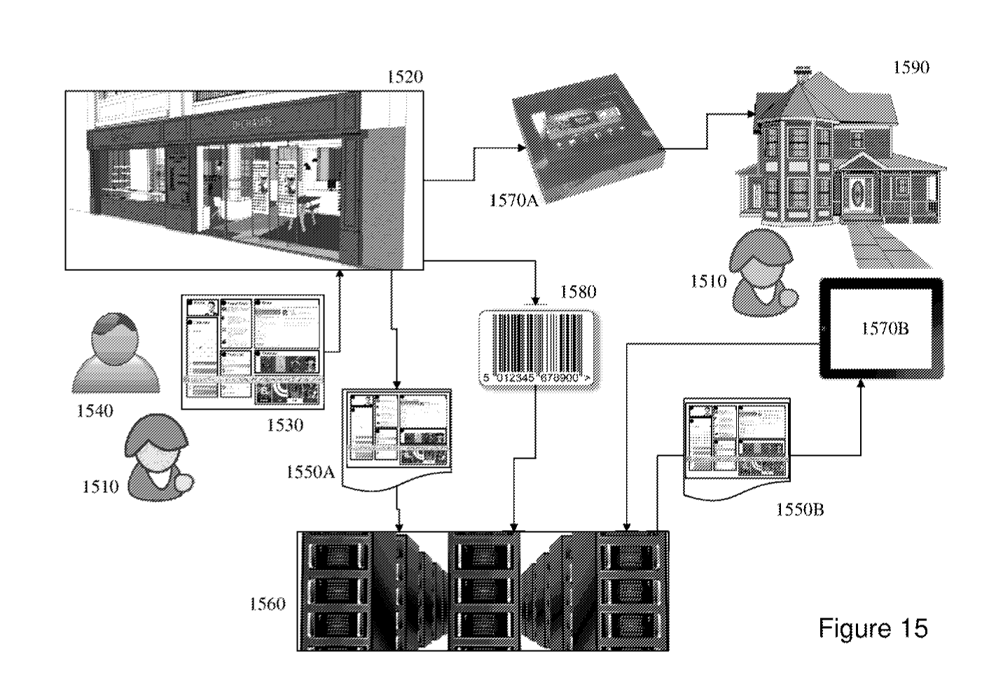

Referring to FIG. 15 depicts a user 1510 and sales agent 1540 based initialization of a user customized contextual based UI dashboard and subsequent transfer to the user's Purchased PED 1570B according to an embodiment of the invention. As depicted user 1510 visits a Retailer 1520 and engages with sales agent 1540. In doing so the sales agent 1540 guides the user 1510 through the process of establishing a customized UI dashboard 1530 upon a Demonstration PED 1570A. The user 1510 decides to purchase a PED of the same or similar type to Demonstration PED 1570A wherein the Retailer 1520 scans the barcode 1580 of the PED 1570A which is transferred to a Server 1560 together with a first file 1550A relating to the customized UI dashboard 1530. The user 1510 upon beginning to use the Purchased PED 1570B is invited to register with a UI service provided by the Retailer 1520. Upon registering a second file 1550B relating to the customized UI dashboard 1530 and the first file 1550A is downloaded to the Purchased PED 1570B from the Server 1560. This second file 1550B thereby provides the customized UI dashboard 1530 to the user 1510.

It would be evident that rather than the service being provided by the Retailer 1520 that the UI service is provided by a third party such as the provider of the operating system or the original equipment manufacturer for example. It would also be evident that second file 1550B may be the same as first file 1550A or a converted form of first file 1550A to reflect differences in configuration and/or operating system of the Purchased PED 157013 relative to that of the Demonstration PED 1570A upon which the customized UI dashboard 1530 was established. It would be further evident that the process as described in respect of providing a customized UI dashboard 1530 to a user 1510 may be exploited in other situations such as for example a first user purchasing a PED for another second user as a gift. It would also be evident that second file 1550B may be a predetermined subset of a plurality of UI dashboards relating for example to the operating system, geographic location, or manufacturer of the Purchased PED 1570B with or without a customized UI dashboard 1530.

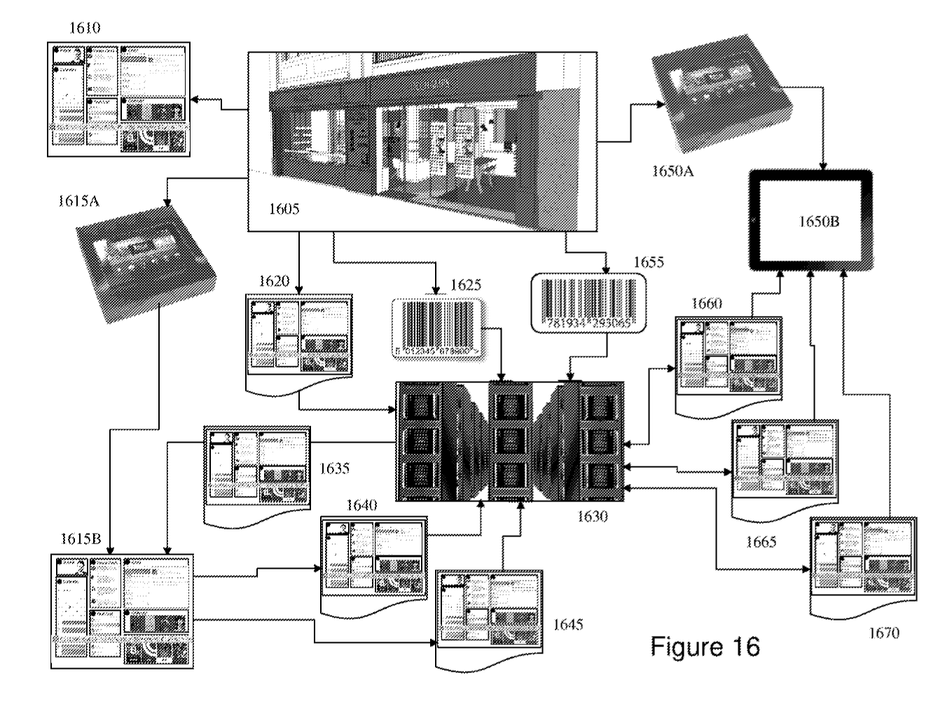

Now referring to FIG. 16 there is depicted a web based server hosting system according to an embodiment of the invention providing recovery and new installation services relating to user customized contextual based UI dashboards according to an embodiment of the invention. Accordingly, a user purchases a Purchased PED 1615A from a Retailer 1605 having for example engaged a sales agent with a Demonstration PED 1610 as described above in respect of FIG. 15. Accordingly, the user, not shown for clarity, takes Purchased PED 1615A home wherein the Retailer 1605 has previously transmitted a first barcode 1625 and first datafile 1620 to a Remote Server 1630. As discussed supra in respect of FIG. 15 the first datafile 1620 relates to a customized UI dashboard established by the user with the sales agent on the Demonstration PED 1610. The user when powering up the Purchased PED 1610 is invited to register with a UI service provided by the Retailer 1605 such that when they then or subsequently register a second datafile 1635 is transferred to their Purchased PED 1615A thereby configuring the customized UI dashboard that they established by the user with the sales agent on the Demonstration PED 1610 onto the Purchased PED 1615A, denoted as Customer PED 1615B in FIG. 16.

Subsequently the user on their Customer PED 1615B, or other users of the Customer PED 1615B such as family members for example, may modify the previously established customized UI dashboard or add new customized UI dashboard which may be contextual or non-contextual according to the requirements of the user or users. Accordingly, through their registration with the UI service these new and modified customized UI dashboards are transferred to the Remote Server 1630, as depicted by first and second Dashboard Datafiles 1640 and 1645 respectively.

At a later point in time the user acquires a Replacement PED 1650A from the Retailer 1605 wherein the Retailer 1605 transmits a second barcode 1655 relating to the Replacement PED 1650A to the Remote Server 1630. Subsequently the user activates the Replacement PED 1650A and registers to the UI service thereby resulting in the PED becoming Activated PED 1650B and third to fifth Dashboard Datafiles 1660 through 1670 respectively being transferred from the Remote Server 130 to the Activated PED 1650B. Each of the third to fifth Dashboard Datafiles 1660 through 1670 respectively relating to one or more UI dashboards associated with the user through their registration with the UI service.

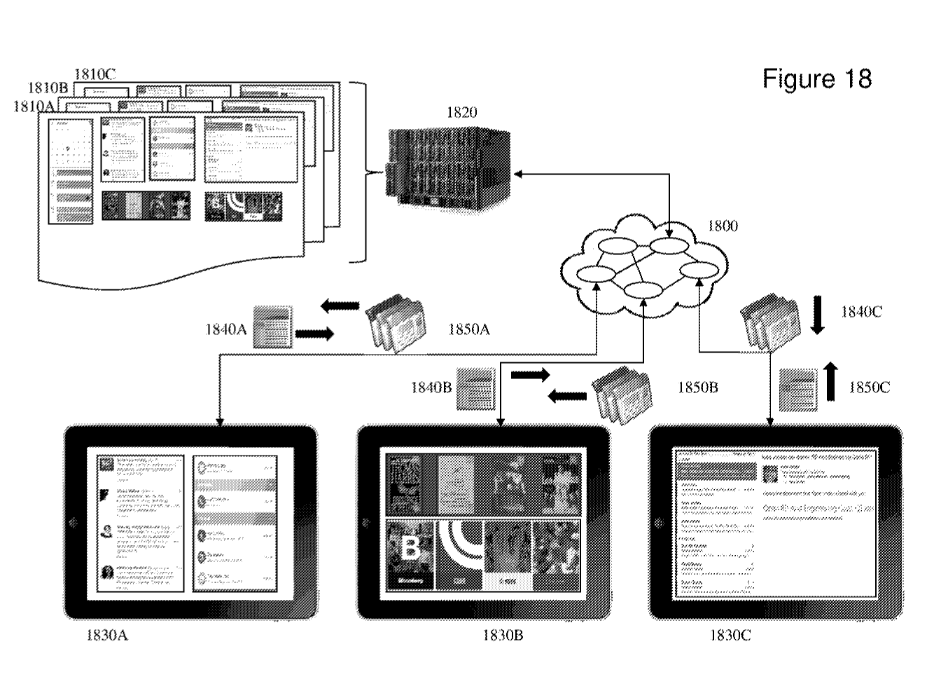

Optionally, a customized UI dashboard transferred from a PED to the remote server or vice versa may be a discrete dashboard, a plurality of associated dashboards, a predetermined portion of a dashboard, or predetermined portions of a plurality of dashboards. In the event that portions of one or more dashboards are transmitted these may for example relate to standard dashboards installed or accessible from a PED and relate only to those elements being modified such that the amount of data transmitted and stored is reduced which is beneficial for example in respect of data transfer to PEDs through a wireless network. Alternatively, the datafile transmitted may include or be solely a template dashboard file such as described below in respect of FIG. 18 thereby establishing preferences for the user rather than custom UI dashboards. It would be evident that rather than the UI service being provided by the Retailer 1605 that the UI service may be provided by a third party such as the provider of the PED operating system, the PED original equipment manufacturer, or a provider of a software application/service such as Facebook™, Twitter™, Google™, Yahoo™, etc. for example.

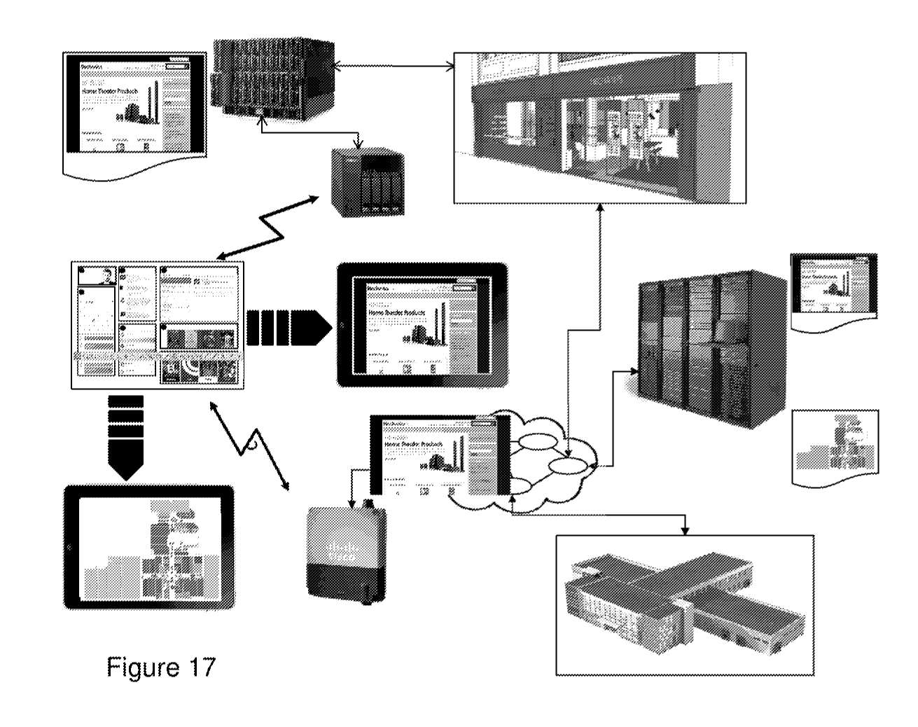

Now referring to FIG. 17 there is depicted web and enterprise based provisioning of non-user defined contextual based UI dashboards according to an embodiment of the invention. Accordingly, a user (not shown for clarity) has a PED 1710A associated with them that supports customized and/or contextual UI dashboards and one or more wireless communication interfaces. Also depicted is Retailer 1720 having a Local Server 1740 and a first Wireless Access Point (WAP) 1750 associated with the location of Retailer 1720 and a communication interface to Remote Server 1780 via Network 1700 either through the Local Server 1740 or another element of the Retailer's 1720 electronic infrastructure. Stored upon Local Server 1740 is first UI Datafile 1730 relating to the Retailer 1720 whilst a second UI Datafile 1760 also associated with the Retailer 1720 is stored upon the Remote Server 1780.

A Mall 1770 is also depicted in communication with the Remote Server 1780 via Network 1700 wherein a third UI Datafile 1790 associated with the Mall 1770 is stored upon the Remote Server 1780. The Remote Server 1780 being connected via Network 1700 to a second WAP 1750B. Accordingly when the user with their PED 1710A comes into communication range of second WAP 1750B a communication session is established between the PED 1710A and Remote Server 1780 resulting in the third UI Datafile 1790 being transferred to the PED 1710A thereby resulting in Mall Dashboard 1710C being displayed to the user on their PED 1710A. As depicted Mall Dashboard 1710C provides the user with a map of the Mall 1770 indicating their location as well as other features including guest services and the specials currently being offered to by retailers within the Mall 1770.

Alternatively, the user with their PED 1710A comes into communication range of the first WAP 1750A wherein a communication session is established between the PED 1710A and Local Server 1740 resulting in the first UI Datafile 1730 being transferred to the PED 1710A thereby resulting in Retailer Dashboard 1710B being displayed to the user on their PED 1710A. As depicted the Retailer Dashboard 1710B provides access to product information, social media links relating to Retailer 1720, account information and store rewards. Alternatively, rather than downloading the first UI Datafile 1730 the communication session results in the second UI Datafile 1760 being retrieved from the Remote Server 1780 and provided to the PED 1710A.

It would be evident to one skilled in the art that each of the Local Server 1740 and Remote Server 1780 may host multiple UI Datafiles relating to different context aware customizable UI dashboards for presentation to the user on their PED 1710A. For example, in the case that Retailer 1720 is an electronics retailer such as Best Buy™ their US stores may provide UI dashboards in English and Spanish whilst their Canadian stores may provide UI dashboards in English and French from their Local Servers 1740. However, users entering their stores may access other UI dashboards through the Remote Server 1780 such that for example a US resident with preference for Spanish may be supported in a Canadian store of Retailer 1720 and a French speaking user may be supported in a US store of Retailer 1720 even though neither Local Server 1740 hosts the datafiles for these UI dashboards.

It would be also evident that a Local Server 1740 may provide multiple dashboards such that the user is provided with a different UI dashboard as they enter the Appliances section of the Retailer's 1720 store to that when they enter the TV & Home Theater section of the store. Alternatively the UI dashboard provided, such as in the instance of language selection, is based upon user preference data transmitted from the user's PED 1710A such that UI dashboard is selected or modified in accordance with the user preference data such as, for example, enabling an audio based UI dashboard for users with reduced visual acuity, providing user account information based upon the association of the user's PED 1710A to an account of the user, displaying pricing data in their preferred currency, or establishing recommendations based upon the user's account and prior purchases with the Retailer 1720. Similarly, the UI dashboard provided to the user within the Mall 1770 may be contextually provided such that whilst a map for example is consistently displayed only offers or information relating to the stores within the immediate vicinity of the user are provided and change as the user moves through the Mall 1770. Similarly, the map may vary as the user moves upon one level of the Mall or changes level.

It would be evident that any enterprise may provide a user with a dashboard on their electronic device using embodiments of the invention as described above in respect of FIG. 17. For example, a restaurant may provide a dashboard with their menu and an ordering interface, a sports arena a dashboard providing fans with multiple video replay options and fan incentives, a hotel a dashboard providing checkin-checkout and guest services etc., and an airport passenger checkin-arrival-departure information with real time updates.

Now referring to FIG. 18 there is depicted customized UI dashboard generation to users by an enterprise in dependence upon templates transferred from their portable electronic devices according to an embodiment of the invention. As depicted a Server 1820 stores first to third UI Dashboards 1810A through 1810C respectively. For example, first UI Dashboard 1810A relates to a first enterprise, for example a retailer; second UI Dashboard 1810B relates to a second enterprise, for example a shopping centre; and third UI Dashboard 1810C relates to a third enterprise, for example a law firm. A user, not shown for clarity, with their first PED 1830A now as the result of an action, such as coming within range of a WAP for example, triggers a process accessing first UI Dashboard 1810A but prior to a datafile being transferred from the Server 1820 to their first PED 1830A via a network 1800 a first Dashboard Template file 1840A is transmitted from their PED 1830A to the Server 1820 thereby resulting in the downloading of first User Specific UI Datafile 1850A. Accordingly, the first UI Dashboard 1810A has been modified in dependence upon the first Dashboard Template file 1840A such that first User Specific UI Datafile 1850A comprises only those elements of the first UI Dashboard 1810A meeting the requirements set by the first user.

Similarly, second and third users with their respective second and third PEDs 1830B and 1830C trigger processes accessing first UI Dashboard 1810A wherein their respective second and third Dashboard Template files 1840B and 1840C are transferred to the Server 1820 resulting in the downloading of second and third User Specific UI Datafiles 1850B and 1850C respectively which comprise only those elements of the first UI Dashboard 1810A meeting the requirements set by the second and third users respectively. Alternatively, rather than datafiles being transferred from the PED to the Server 1820 and customized dashboard datafiles being downloaded a single common UI Dashboard datafile may be transferred to each PED and dynamically configured for display on a PED in dependence upon the user's Dashboard Template file. For example, the second user may have poor visual acuity such that their dashboard is displayed at a large font size or that dashboard elements with high resolution detail are omitted and/or adjusted.

Optionally, the Dashboard Template files may be employed to determine whether another dashboard of the plurality of dashboards stored at the Server 1820 should be retrieved or even that elements from two or more dashboards should be combined. Optionally, two or more dashboards may be downloaded to the PED and the required elements combined locally at the PED rather than remotely at the Server 1820. It would be evident that accordingly a dashboard may be generated based upon user preferences or settings associated with the user in such instances rather than requiring the user to generate such as customized UI dashboard themselves.

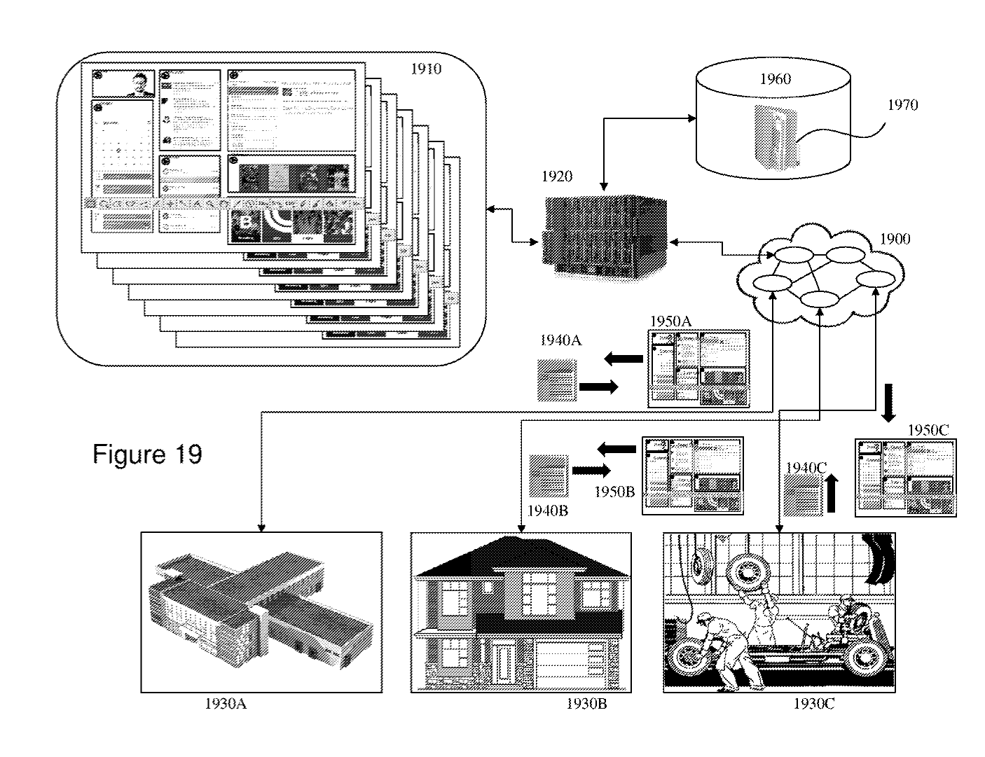

Referring to FIG. 19 there is depicted customized contextual UI dashboard provisioning to a user upon different devices accessed in different locations. Common with other embodiments of the invention a Server 1920 hosts a plurality of user customized contextual UI dashboards 1910. These may have been established onto Server 1820 by a process such as that described above in respect of FIG. 16 for example based upon user selections or alternatively may reflect standard dashboards relating to an enterprise or enterprises. Accordingly, a user, not shown for clarity, accesses an electronic device in each of first to third locations 1930A through 1930C respectively by registering with a service hosted upon Remote Server 1920 via a network 1900. During the process of registering data is extracted by the process in execution upon the Remote Server 1920 from each of the electronic devices, depicted as first to third Electronic Device Datafiles 1940A through 1940C respectively. At its simplest an Electronic Device Datafile may be, for example, an identity of the electronic device, an Internet Protocol (IP) address, or a network identity. At higher complexities the Electronic Device Datafile may comprise information, including but not limited to, IP address, time and date information, local environment in terms of other electronic devices, and network association. The information within the user registration in conjunction with, or in isolation of, the Electronic Device Datafile may be compared with a User Profile 1970 stored within a Database 1960 associated with the Server 1920.

Accordingly based upon the information extracted the user is provided with a dashboard transferred from the Remote Server 1920, these being depicted as first to third UI Dashboard Datafiles 1950A through 1950C respectively. For example, first location 1930A when compared to the locations within User Profile 1970 stored within the Database 1960 and/or the information associated with the user customized contextual UI dashboards 1910 is determined as being outside contexts such as “Home” and “Work” for example such that first UI Dashboard Datafile 1950A is a “Travel” dashboard for the user wherein they have established such a contextual dashboard. In the event that such a user customized dashboard has not been established the process may elect to transfer a default “Travel” dashboard for the user to exploit. As described above in respect of FIG. 16 for example if the user modifies the default “Travel” dashboard this may be communicated back to the Server 1920 and stored therein for subsequent retrieval as a user customized contextual dashboard for a “Travel” scenario.

Similarly, in second and third locations 1930B and 1930C respectively the process results in an appropriate selection and downloading to the electronic device of a dashboard selected upon the location/context information available to the process. Accordingly, in second location 1930B the process establishes the context as “Cottage” and in third location 1930C as “Work.” According in this embodiment of the invention a user, who has not previously accessed a particular PED, may be provided with their own customized contextually derived UI dashboard for that context from a remote store of their dashboards.

According to the embodiments of the invention described above in respect of FIGS. 1 through 19 that a user has been stated as registering with a service to remotely access their user customized contextual dashboards. However, it would be evident that this process may be automated such as for example wherein the electronic device performs biometric identification of a user their registration credentials are automatically transmitted to the service. Such a process of biometric identification is described in U.S. Provisional Patent Application 61/584,288 entitled “Method and System for Dynamically Assignable User Interface”, the entire contents of which are included by reference. It would also be evident that the transfer of data relating to a user customized UI dashboard may be transferred between electronic devices wherein a network connection may be established between the devices. Such transfer may require the provisioning of credentials relating to the user to authorize the transfer. The presentation and verification of user credentials, passwords, and other security information may also form part of the embodiments presented supra in respect of FIGS. 1 through 19.

It would be evident to one skilled in the art that where a user customized contextual dashboard is transferred to an electronic device other than that associated with the user that the user customized contextual dashboard may be removed from the electronic device once the user has finished or logged out. The removal may be securely executed.

Within embodiments of the invention as described above in respect of FIGS. 1 through 19 that the electronic device has been typically referred to as a portable electronic device. However, it would be evident that these embodiments of the invention may also be employed upon fixed electronic devices. It would be evident to one skilled in the art that the concepts discussed above in respect of contextual dashboards whilst being primarily considered from the viewpoints of tablet computers, smart phones, laptop computers and similar portable electronic devices that the underlying principles may be applied to a wider variety of devices including for example portable gaming consoles, such as Nintendo DS and Sony PSP; portable music players such as Apple iPod, and eReaders such as Kobo, Kindle, and Sony Reader. It would also be evident that whilst the embodiments of the invention have been described with respect to a III that they may also be employed within software applications that form part of a contextual dashboard or as discrete stand applications in other operating environments such as Windows, Mac OS, Linux and Android for example.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. A method comprising:
storing upon a remote server a plurality of first datafiles, each first datafile relating to a contextual dashboard of a plurality of contextual dashboards;
storing upon the remote server context data with respect to the plurality of contextual dashboards, the context data being associated with each contextual dashboard of a plurality of contextual dashboards and establishing one or more criteria relating to displaying a contextual dashboard of a plurality of contextual dashboards;
receiving at the remote server first data relating to an electronic device and an identity of a user associated with the electronic device;
receiving at the remote server second data associated with a predetermined subset of the plurality of contextual dashboards;
receiving at the remote server data relating to a context of the electronic device; and
transmitting to the electronic device from the server a plurality of second datafiles, each second datafile comprising a predetermined portion of a first datafile of the plurality of first datafiles associated with a contextual dashboard within the predetermined subset of the plurality of contextual dashboards associated with the second data and having the context of the electronic device meeting the context data criteria stored in association with each contextual dashboard of the plurality of dashboards upon the remote server; wherein the context of the electronic device comprises an identity of a user registered upon the electronic device, a macro context of a plurality of macro contexts, and a micro context of a plurality of micro-contexts; and each macro context of the plurality of macro contexts has associated with it a predetermined subset of the plurality of micro-contexts.

2. The method according to claim 1, wherein
the first data relating to an identity of the electronic device and the identity of the user are established during a transaction associated with the purchase of the electronic device;
the second data relates to a retailer from whom the electronic device was purchased; and
the context of the electronic device comprises its geographical location and that it is an initial use after purchase; wherein the predetermined subset of the plurality of contextual dashboards relate to at least one of an operating system of the electronic device, a manufacturer of the electronic device, the retailer of the electronic device.

3. The method according to claim 1, wherein receiving the first data relating to the identity of the user comprises receiving registration data of the user to a service provided by a third party relating to the storage upon the remote server of the plurality of first datafiles and the context data and the transmittal of the plurality of second datafiles.

4. The method according to claim 1, further comprising:
receiving at the remote server third data relating to a modification made to a predetermined contextual dashboard of the plurality of contextual dashboards by the user; wherein subsequent transmittal or retrieval of the predetermined contextual dashboard of the plurality of contextual dashboards provides the updated user modified contextual dashboard of the plurality of dashboards.

5. The method according to claim 1, further comprising:
receiving at the remote server another first datafile relating to a new contextual dashboard generated by the user of the electronic device; and
receiving at the remote server additional context data for establishing a set of criteria relating to displaying the new contextual dashboard;
storing the another first datafile and the additional context criteria upon the remote server.

6. The method according to claim 1, further comprising:
receiving at the server prior to transmitting the selected dashboard a dashboard template associated with the electronic device and the user; wherein each second datafile of the transmitted plurality of second datafiles is a modified version of a first datafile of the plurality of first datafiles generated in dependence upon the dashboard template.

7. The method according to claim 1, further comprising:
receiving at the server prior to transmitting the plurality of second datafiles third data relating to an identity of a second electronic device associated with the user; wherein transmitting the plurality of second datafiles comprises transmitting the plurality of second datafiles to the second electronic device; wherein the third data relating to the identity of the second electronic device was obtained at a point of sale terminal during a transaction associated with the purchase of the second electronic device.

8. The method according to claim 7, further comprising:
receiving at the remote server prior to transmitting the plurality of second datafiles third data relating to a second electronic device associated with the user;
receiving and storing at the remote server a template file relating to preferences of the user; and transmitting the plurality of second datafiles comprises modifying the plurality of second datafiles in dependence upon the template file prior to transmitting the plurality of second datafiles to the second electronic device.

9. The method according to claim 1, further comprising:
receiving and storing at the remote server a template file relating to preferences of the user; transmitting the plurality of second datafiles comprises modifying the plurality of second datafiles in dependence upon the template file prior to transmitting the plurality of second datafiles to the electronic device.

10. The method according to claim 1, wherein the selected contextual dashboard is processed by the electronic device in dependence upon a dashboard template associated with the electronic device and the user.

11. The method according to claim 1, wherein the plurality of first datafiles and their associated context data were previously transferred to the remote server from another electronic device associated with the user; and when transmitted to the electronic device the plurality of second datafiles are modified in dependence upon at least one of configuration variations and operating system variations between the another electronic device and the electronic device.

12. The method according to claim 1, wherein the plurality of first datafiles comprises at least one of a single contextual dashboard, a plurality of associated contextual dashboards, a predetermined portion of a contextual dashboard, and predetermined portions of a plurality of contextual dashboards.

13. The method according to claim 1, wherein the context data relating to the one or more criteria comprises for each contextual dashboard of the plurality of contextual dashboards macro-context information and micro-context information.

14. The method according to claim 1, wherein the second data relates to a third-party which generated and stored the predetermined subset of the plurality of contextual dashboards upon the remote server.

15. The method according to claim 1, wherein the second data relates to a service provider providing a service to which the user has registered, wherein the service provides users with remote backing up and archiving of contextual dashboards and non-contextual dashboards.
